(19) United States
(12) Patent Application Publication
(10) Pub. No.: US 2003/0163375 A1
(43) Pub. Date: Aug. 28, 2003

(54) Methods, systems, and options for publication advertisement information management

(76) Inventors: Paul Joseph Dombrowski, Hammond, IN (US); Michael Richard Skurski, Lake Zurich, IL (US)

Correspondence Address: McAndrews, Held & Malloy, Ltd., 34th Floor, 500 W. Madison Street, Chicago, IL, 60661, US

(21) Appl. No.: 10/375,579

(22) Filed: Feb. 25, 2003

Related U.S. Application Data
(60) Provisional application No. 60/359,633, filed on Feb. 26, 2002.

(51) Int. Cl. G06F 17/60

(52) U.S. Cl. 705/14

(57) ABSTRACT

The preferred embodiments of the present invention provide a system and method for the improved management and distribution of advertising specifications for publications. The management system preferably includes a plurality of publishers, a central repository, and a plurality of users. The publisher develops a set of advertisement specifications for use with their publication and posts the specifications as a template on their server. The set of advertisement specifications is then retrieved and stored at the central repository by an intelligent software agent. Templates stored at the central repository may then later be requested by any of a plurality of users, such as advertising agencies, for use in creating advertisements. The central repository preferably stores sets of advertisement specifications representing a large number of publications so that the user may use the central repository as one-stop-shopping for all the user's specification needs for a variety of publications.

### CROSS-REFERENCE TO RELATED APPLICATIONS

This application claims priority to U.S. Provisional Patent Application No. 60/359,633 filed Feb. 26, 2002 entitled “Device and Method For Posting, Distributing, Retrieving, and Using Production Specifications For Publication Advertising Pages.”

### BACKGROUND OF THE INVENTION

The present invention generally relates to systems and methods for managing publication advertisement information. More specifically, the present invention provides an automated solution for the real-time management and distribution of literally thousands of publication advertisement specifications among the multitude of process entities involved in the advertising production chain.

Most publications, such as TIME Magazine, for example, include content such as news and editorials as well as advertising space. Advertising space in a publication is typically sold to persons wishing to buy the advertising space in the publication to showcase a product or service, for example. Typically, the purchaser of the advertising space is an advertising agency. The advertising agency typically represents an advertiser, such as Ford Motor Company, for example, that is seeking to advertise a product or service to a consumer. The advertising agency may simply be responsible for the placement of an advertisement in the publication, or may also have creative input into the development of the advertisement.

Often an advertiser works with an advertising agency to develop an ad campaign. Typically, the ad campaign includes the placement of an advertisement in the advertising space of a number of periodicals. The number of periodicals that may include the ad may be quite large, often representing tens to hundreds of periodicals for a major advertising campaign.

Unfortunately, few publications are exactly identical in terms of their actual page layout and printing processes. As an example, the appearance of the publication may be influenced by the printing machinery upon which the publication is printed. For example, different printing machinery may support different colors or texturing, or may employ a different coloring system. Additionally, different printing machinery may bind a publication using different binding methods which may impact where on a page an ad is to be positioned or change the margining of an advertisement page. Also, some publications may be in color while others may be in black and white, or a combination of color and black and white.

Also, the advertising agency may wish to run the ad using different display criterion in different publications. For example, an ad may be a full page in a first publication and an eighth or quarter-page ad in another publication. The advertising agency may wish some ads to be run in color and some ads to be run in black and white.

In order to inform the advertising agencies as to the specific requirements and limitations of advertising to appear in a publication, the publishers of the publication make the requirements and limitations available to the advertising agencies. Consequently, in order to determine whether an advertisement may be placed in a publication as desired by an advertising agency, the agency must first consult the advertising specifications for the publication. Additionally, further complicating the task is the fact that a publication's advertising specifications may be changed often, for example as new machinery or processing techniques become available.

However, the advertising specifications are typically kept on file at the publisher of the publication. In order to retrieve the advertising specifications, the advertising agency must communicate with the publisher, typically by phone or fax. Additionally, because a typical advertisement passes through many hands during production, typically many instances arise wherein a person employed at the advertising agency must contact the publisher in order to retrieve the advertising specification. Additionally, the advertising agency typically also deals with third parties such as a prepress service provider or a photographer or media purchasing agency who may also have to contact the publisher with regard to advertising specifications.

Such a system of repeated contacts with the publisher is inefficient and costly with regard to time and resources. A need has long been felt for an improved method and system for managing publication advertisement information.

FIG. 1 illustrates an overview of the magazine advertising production enterprise 100. The ad production enterprise 100 includes an advertiser 101, an advertising agency 105, creative services resources 110, a publisher 115, a publication printer 130, a distribution system 135, and a user/consumer 140. The creative services resources 110 preferably include a photographer 119, an ad layout system and other creative resources 120, and a prepress service provider 125. Additionally, the ad production enterprise 100 may include a commercial printer 145, and material and supplies manufacturers 150.

In operation, as generally described above, the advertiser 101 may be a manufacturer or provider of services seeking to advertise in a publication. The advertising agency 105 may be contracted by the advertiser 101 in order to place an advertisement in a publication and/or develop an advertisement for placement in a publication. The publisher 115 typically specifies advertisement specification information that must be followed to place advertisements in the publication. The advertising agency 105 typically retrieves the advertisement specification information from the publisher 115 and shares the advertisement specification information with the creative services resources 110 and a prepress service provider 125. Once an ad had been completed, the publisher 115 typically receives the digital files or films, and ensures that there is a manual monitoring and inspection process to verify that the digital file, film integrity and proofs conform to specifications. The publisher 115 then instructs the publication to be printed at the publication printer 130. Once the publication has been printed, copies of the publication are sent to the distribution system 135 for distribution to the user/consumer 140. The user/consumer 140 is the end-user, reader, and target of the magazine advertisement. Typically, the user/consumer 140 is a prospective purchaser or customer of the advertiser 100.

As is seen from FIG. 1, at each step of the ad production enterprise 100, a common set of publication information specifications, as defined by the publisher 115, must be relied upon to successfully place the ad in the publication.

Expanding upon the elements of the ad production enterprise 100, the advertising agency 105 is typically the creator of the magazine advertising and the architect of the advertising campaign for the advertiser 101. The advertising agency 105 purchases advertising space on behalf of advertiser 101 from the publisher 115. The publisher 115 assembles advertising together with editorial and passes the assembled content to the prepress service provider 125. The prepress service provider 125 then prepares the advertising and editorial for reproduction, proofing, and distribution and sends the assembled content to the publication printer 130 for print, bindery, finishing/mail distribution.

The advertising agency 105 typically uses publication information to contract the purchase of advertising space and produce advertising materials to reproduce within the contracted advertising space. The advertising agency's responsibility is to specify that all supplied advertising materials, regardless of origin, be made to specifications and to insure that there is a monitoring and inspection process to verify conformance. The prepress service provider 125 serves the advertising agency, publisher, and publication printer. The prepress service provider's responsibility is to prepare input material for publication printing in accordance with specifications. The publication printer's 130 responsibility is to receive digital files, films, proofs, and ensure that nothing has been changed or lost during delivery, that all components have been received and comply with specifications.

As mentioned above and as is seen from FIG. 1, at each step of the ad production enterprise 100, a common set of publication information specifications, as defined by the publisher 115, must be relied upon to successfully place the ad in the publication. The publication information specifications typically include two types of information: 1) mechanical specifications for construction and delivery of the advertising, and 2) rate card information. The mechanical specifications for construction and delivery of the advertising materials typically include, but are not limited to: size (trim, bleed, live area for page, spread and fractional ads), contact information, digital file format, proofing requirement, printing and bindery method, close dates for supplying materials, and other information for instructing the correct delivery of advertising materials from the advertiser to the publisher and on to the publication printer. Rate card information typically includes but is not limited to advertising rates, advertising space, and financial aspects of the purchase transaction between the advertising agency and the publisher.

As mentioned above, several industry standards may be used by publishers in setting forth the set of publication specifications for use in their publication. These industry standards include: Specifications for Web Offset Publications (SWOP), Specifications for Newsprint Advertising Production (SNAP), Gravure Association of America Input Specifications for Publication Gravure (GAA/SWOP) and General Requirements for Applications in Commercial Offset Lithography (GRACOL).

As mentioned above with regard to FIG. 1, the set of publication information specifications that is developed by the publisher is circulated to the other entities involved in the ad production enterprise 100. Presently, the circulation of the set of publication information takes place manually. That is, the publisher typically types or writes out by hand one or more sheets of paper embodying the set of publication information specifications. Although the set of publication information specifications may be grouped onto a form with recognized blanks and/or options to be circled, the process is typically paper-based. Once the paper form is completed, it may be faxed to the other entities in the ad production enterprise 100 or may be physically passed via mail, for example.

FIG. 11 illustrates an exemplary publisher's manual paper-based form utilized for data collection to construct the set of publication information. The publication information form typically includes: publication title, preferred materials, file types, platform, media transport methods, proof requirements and advertisement related technical support contact information and is completed by the publisher. As seen in FIG. 11, the publication information form includes a number of areas for written entry of data as well as options of check boxes that may be indicated.

As mentioned with regard to FIG. 1, once the publication information form has been completed by the publisher the publication information form is circulated to the other entities involved in the ad production enterprise 100 including advertising agency 105, the prepress service provider 125, and the publication printer 130. Additionally, the publication information form may need to be periodically re-accessed or updated internally at the publisher 115.

FIGS. 2-5 illustrate some of the internal workings of the entities involved in the ad production enterprise 100 in greater detail so as to illustrate the number of times and conditions under which the publication information form is typically accessed during the production of an ad. With reference to the entities shown in the ad production enterprise 100 of FIG. 1, greater detail of the access to the publication information form is shown for the publisher 115 in FIG. 2, the advertising agency 105 in FIG. 3, the prepress service provider 125 in FIG. 4, and the publication printer 130 in FIG. 5.

As mentioned above, FIG. 2 illustrates some of the internal procedures of the publisher 115 of FIG. 1. As illustrated in FIG. 2, the publisher typically proceeds through a series of steps to make the publication ready for printing. First, at step 200, advertising space is sold in the publication and the page count for the publication is determined. Next, at step 205, editorial content is created. Then, at step 210, art for the publication is created and edited. At step 215, the editorial content and art is reviewed. If the editorial content requires revision, the procedure proceeds back to step 205. If the editorial content is approved, the procedure proceeds to step 220. At step 220, advertising is placed in a dummy or prototype layout to allow the publisher to verify the correct placement of the editorial content, artwork, and ads. Next, at step 225, prepress services are performed to prepare the publication to be sent to the printer. Finally, at step 230, the publication is sent to the printer.

As shown in FIG. 2, the publication information form is typically accessed several times by the publisher during the publisher's operation. First, at step 240, the publication information form is constructed by the publisher and distributed, for example to ad agencies as is further described below. Additionally, the publication information form is typically accessed at step 250 when the ad placements in the dummy or prototype layout is performed. Additionally, the publication information form is also typically accessed during the prepress services to conduct a final review of the ad layout before the publication is sent to the printer.

Turning now to FIG. 3, FIG. 3 illustrates some of the internal procedures of the advertising agency 105 of FIG. 1. As illustrated in FIG. 3, the ad agency typically proceeds through a number of steps to develop an advertisement and place the advertisement in a publication. First, at step 300, an advertiser plan is developed by the ad agency in conjunction with an advertiser. Next, at step 305, a media plan is developed by the ad agency to determine the publications into which ads will be placed. Once the publications have been determined, ad space is reserved in the publications. At step 310, the advertising agency and the client advertiser work together to develop an advertising campaign. At step 315, the advertiser provides the advertising agency with a job order/request. At step 320, the ad agency develops ad concepts and copy layout. At step 325, the ad agency determines the mechanical specifications of a proposed publisher and schedules their internal production to meet the closing date for advertisement to be included in the publication. At step 330, the art director at the advertising agency works on the advertising campaign. At step 335, photography and/or illustrations are created for the ad. At step 340, layout of the advertising is created by a desktop artist and the layout artist and the art director work together to refine the advertising in step 345. At step 350, production personnel review the reproduction materials. Next, at step 355, the print operations section of the ad agency provides schedule, materials and shipping information. At step 360, the production personnel send the insertion order to the publication. At step 375, the insertion order is received by the publisher. At step 360, the production personnel reviews and orders materials for distribution to the publication. At step 370, the production personnel send the materials to the publication. Finally, at step 375, materials are received by the publisher.

As shown in FIG. 3, the publication information form is typically accessed many times by the ad agency during the ad agency's operation. Each point at which the ad agency typically manually accesses the publication information form is shown in FIG. 3 is indicated by a large “M” signifying manually accessing the publication information form. As shown in FIG. 3, the publication information form may be accessed at step 387 when the ad agency is initially developing the advertiser plan. Additionally, the publication information form may be accessed at step 389 when the media plan is developed and space is reserved. Also, the media plan may be accessed at step 391 when the job order is first executed, step 393 when the ad concepts and color layout are performed, and at step 395 when the mechanical specifications of the publisher and the publisher's closing date are determined. Additionally, the publication information form may be accessed at step 377 when the photography or illustrations are developed at step 379 when the layout of the ad is first generated by the desktop artist. Finally, the publication information form may be accessed during production review at step 381, print operations at step 383, and at final ad insertion at step 385.

Turning now to FIG. 4, FIG. 4 illustrates some of the internal procedures of the prepress service provider 125 of FIG. 1. As illustrated in FIG. 4, the prepress service provider typically proceeds through a number of steps. First, at step 400, the prepress service provider receives the original art, digital files and proofs from the advertising agency. The job confirmation and preflight of the materials occurs in step 405. The prepress service provider determines and utilizes the publication specifications in step 410. The layout of the advertisement is set to the required specification sizes in step 415. The art element is placed within the layout in step 420. The desktop artist executes the page assembly in step 425. A proof of the advertisement is created in step 330. The proof is evaluated in step 435. If changes are necessary, the changes are performed by the desktop artist in step 425. If the proof is approved, press proofs are created in step 440. The final files, proofs, films and/or Computer to Plate (CTP) are manufactured in step 445. The materials are prepared for shipment in step 450. The materials are received by the publication printer in step 455.

As shown in FIG. 4, the publication information form is typically accessed many times by the prepress service provider during the prepress service provider's operation. As indicated in FIG. 4 at steps 495, 490, 485, 480, 475, 465 and 460, the publication information form is typically manually accessed with regard to a large number of the prepress service provider's activities.

Turning now to FIG. 5, FIG. 5 illustrates some of the internal procedures of the publication printer. First, at step 500, the Publication Printer receives materials from the publisher. The Printer inspects the film, files and proofs for defects in step 505. The files are assembled in press sheet layout in step 510. The film or files are submitted to archival storage in step 515. The press sheet layout is proofed and the proof is sent to the publisher for review in step 520. The press sheet layout is added to the other press sheet forms in step 525. The press sheet layouts are converted to printing press plates in step 530. All forms of the publication are proofed and sent to the publisher for review and approval in step 535. The publication is printed in step 540. The printed publication sheets are reviewed and inspected in step 545. The press sheets are converted to the finished publication (collated, bound and trimmed) and distributed in step 550.

As shown in FIG. 5, the publication information form is typically accessed many times by the publication printer during the publication printer's operation. As indicated in FIG. 5 as steps 555 and 560, the publication information form is typically manually accessed with regard to several of the printer's activities.

The use of the publication information form suffers from several drawbacks. First, a publication's advertising information is constantly changing. The advertiser must receive accurate and up-to-date information from the publisher. This information is needed to make decisions about purchasing advertising space. Publication information is also needed to guide the preparation and distribution of advertising for magazines. Another recent problem is that publishers may update publication information at different times at different outlets. For example, revised publication specification may be immediately posted on a web site, but the revised specifications may not be sent to advertising agencies for days.

Additionally, the prior art suffers the drawback of being a manual process that requires telephone calls, facsimile transmissions, and manual visits to web sites to gather and distribute publication information. As may be seen, this is typically quite time intensive. Additionally, the prior art method of data collection (of publication information) requires manual reading and translation and manual data entry. Thus allowing for user error to occur.

Another drawback to the prior art is the variety of reporting styles that are typically employed. For example, measuring conventions may be in inches or centimeters or may be in decimals or fractions. Additionally, file formats may be described in a wide variety of ways.

Another problem with the prior art is that it does not allow publication information data to stream into the users' business systems. Instead the publication information form merely displays data and is not usable by automated systems. Consequently, upgrades to process systems, such as is required for ISO 9002 Registration, is not possible. Additionally, integrating the publication data directly into the page layout application files that are employed by the advertising agency is also not possible. Additionally, publication information data is not able to be integrated into an automated manufacturing process.

Thus, a need has long been felt by partners in the magazine advertising production enterprise for a business system for preparing, publishing, exchanging, and analyzing publication specifications to make them more accessible, timelier, more consistent and ultimately more efficient for advertising page production. The prior art fails in delivering timely information because it relies principally upon manual methods of data collection and data entry.

### SUMMARY OF THE INVENTION

The preferred embodiments of the present invention provide a system and method for the improved management and distribution of advertising specifications for publications. The management system preferably includes a plurality of publishers, a central repository, and a plurality of users. Each of the plurality of publishers develops a template for advertising to be included in their publication. The templates are then retrieved from the publishers and stored at a central repository. Any of a plurality of users may then retrieve and of the templates from the central repository at a later time for use in making advertising materials. The central repository preferably stores a large number of templates so that the used may use the central repository as one-stop-shopping for advertising templates for a variety of publications.

### BRIEF DESCRIPTION OF THE DRAWINGS

FIG. 1 depicts an overview of the magazine advertising production enterprise.

FIG. 2 depicts an overview of the Publisher segment of the magazine advertising production enterprise.

FIG. 3 depicts an overview of the Advertising Agency segment of the magazine advertising production enterprise.

FIG. 4 depicts an overview of the Prepress Service Provider segment of the magazine advertising production enterprise.

FIG. 5 depicts an overview of the Publication Printer segment of the magazine advertising production enterprise.

FIG. 6 depicts the flow chart of the method of this invention.

FIGS. 7A-B depict one embodiment of the standardized data template for the publication information including contact information.

FIGS. 8A-E depict an additional embodiment of the standardized data template for the publication information including sizing information.

FIG. 9 depicts an electronic computer which functions with software instructions to accomplish the invention.

FIGS. 10A-D depict an additional embodiment of the standardized data template for the publication information.

FIG. 11 depicts an example of the manual paper-based form utilized for data collection of the prior art system.

FIGS. 12A-E depict an additional embodiment of the standardized data template for the publication information including sizing information.

FIGS. 13A-D depict an additional embodiment of the standardized data template for the publication information including material specifications.

FIGS. 14A-C depict an additional embodiment of the standardized data template for the publication information including rate information.

FIG. 15 is similar to FIG. 2, but shows the interaction of the automated publication specification template distribution and retrieval system with the publisher's activities.

FIG. 16 is similar to FIG. 3, but shows the interaction of the automated publication specification template distribution and retrieval system with the ad agency's activities.

FIG. 17 is similar to FIG. 4, but shows the interaction of the automated publication specification template distribution and retrieval system with the prepress service provider's activities.

FIG. 18 is similar to FIG. 5, but shows the interaction of the automated publication specification template distribution and retrieval system with the publication printer's activities.

FIG. 19 depicts the points where data fields defined in FIGS. 7A-B, 8A-E, 10A-D, 12A-E, 13A-D, and 14A-C are posted displayed and/or reported.

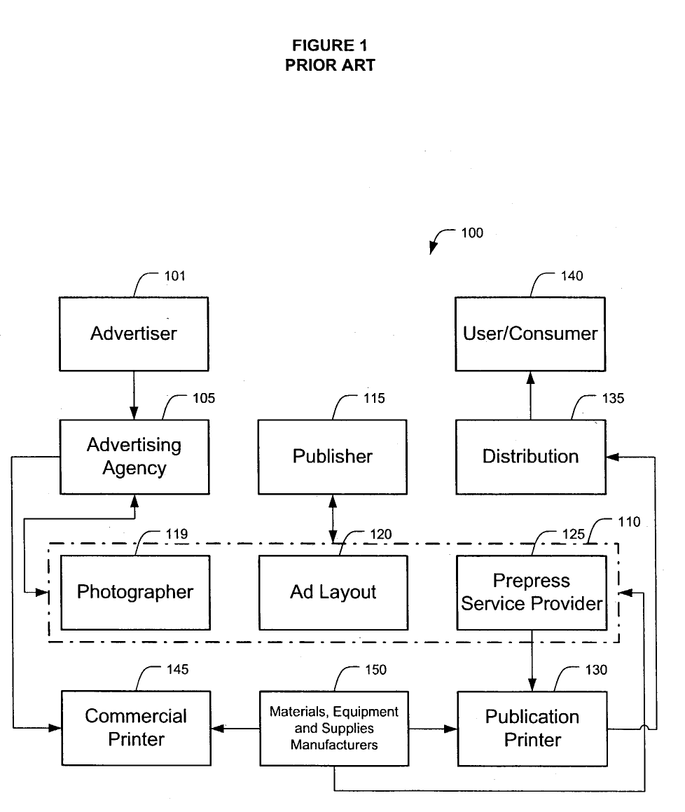

### DETAILED DESCRIPTION OF THE PREFERRED EMBODIMENT

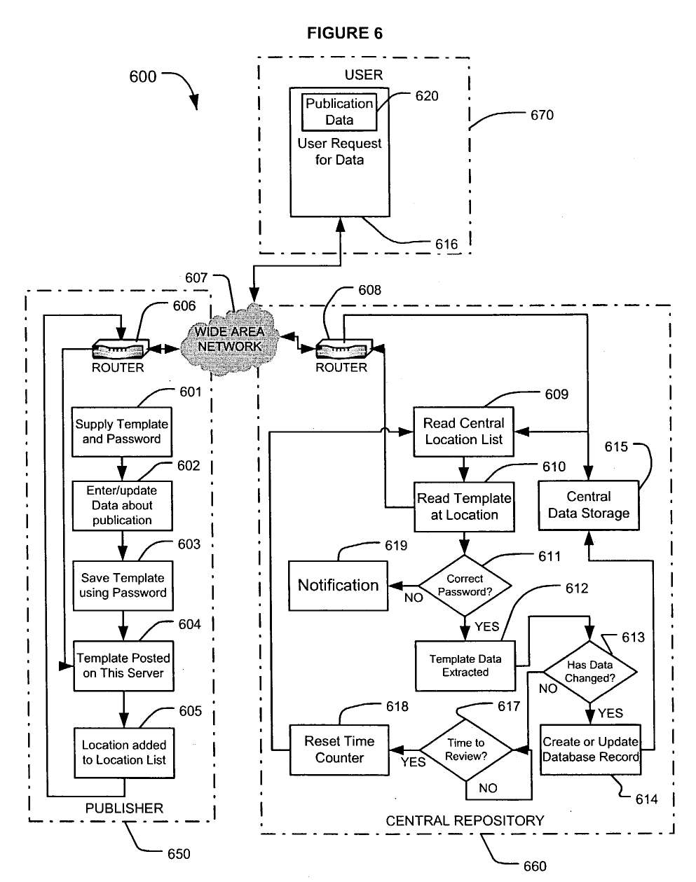

FIG. 6 illustrates an improved publication advertisement specification management system 600 according to a preferred embodiment of the present invention. The management system 600 preferably includes a publisher 650, a central repository 660 and a user 670. As further described below, the publisher develops a set of advertisement specifications for use with a publication. The set of advertisement specifications may then be stored at the central repository 660 for later retrieval by the user 670. The central repository 660 preferably stores sets of advertisement specifications representing a large number of publications so that the user 670 may use the central repository 660 as one-stop-shopping for all the user's specification needs for a variety of publications.

Turning now to the publisher 650, at step 601, a template of advertisement specifications is developed at the publisher 650. Access to the template is preferably protected by password or other security mechanism. Next, at step 602, the template may be modified at the publisher 650. For example, the template may be first created or one or more elements of the template may be changed. Next, at step 603, the template is saved and preferably password protected.

Once the changes to the template have been accomplished and the template has been saved, the new template is posted to a server at step 604. That is, the template with all the publication information is made available on a server that is accessible preferably by using a wide area network or an internet connection.

At step 605, if the publisher has not already provided the location of the template to the central repository 660, the location of the template is now provided. For example, if a new template has just been created at the publisher or the location of the template at the publisher has been changed, the publisher preferably sends the new location to the central repository 660. Alternatively, if a new template is being stored in the location of the former template, the location need not be sent to the central repository 660 and the central repository may simply re-index the new specification at the previously sent location. Alternatively, the central repository may simply periodically search the publisher's domain or website until it recognizes publication data and then import that publication data directly.

At step 607, the location information is sent to the central repository 660 through a router. That is, the location information travels through a publisher-side router 606, a wide area network 607 and a repository-side router 608 to reach the central data storage 615 at the central repository 660. As will be appreciated by those of skill in the art, the number of routers and/or the precise network architecture is not central to the present innovation and may be implemented in a variety of ways.

At the central repository 660, at step 617, a logic timer tests to determine if it is time to review the template placed in step 604. For example, the timer may initiate a review based on a predetermined time interval such as hourly or daily. Alternatively, the timer may initiate a review when a predetermined number of changed locations or templates has been received.

At step 617, if it is not time to review the template, the timer returns to step 617 and waits. If the timer determines that it is time to review the template, the timer first resets the time count in step 618. The process continues to step 609 and examines the central location list. At step 610, the first location of the template is read from the central location list. Additionally, while reading the location of the template, the process also preferably reads the optional password.

The central repository 660 then proceeds to retrieve the new template information from the publisher 650. That is, the central repository 660 passes the password to the server at the publisher 650. If the incorrect password is passed to the publisher 650, the access request fails and a notification is logged in step 619. If the password is correct, the central repository 660 is allowed access to the publisher 650 and the template data is extracted in step 612.

At step 613, once the template data is extracted by the central repository 660, the central repository 660 examines the template data and compares the template data to the currently stored template data. At step 614, if the newly retrieved template data differs from the stored template data, the newly retrieved template data is stored at the central repository 660. Preferably, the template data is stored as a data base record at the central repository 660. Thus, if a new template is being added, a new database record is preferably created. If a template is being updated, the database record corresponding to the template may simply be updated.

Alternatively, if the newly retrieved template data is compared to the existing template and the templates are the same, the process proceeds to step 617. The database record is not updated because no new template information is available. The process proceeds to step 617 and waits until the predetermined time has elapsed, as described above.

Turning now to the user 670, at some time in the future, the user 670 seeks to retrieve a template from the central repository 660. Thus, at step 616, the user 670 requests publication specification information. The user's request for data in step 616 may use one of several methods including but not limited to a direct database query and various forms of client modules that query the database. The query may be communicated through the wide area network 607. The wide area network communicates with the router 608. The router 608 communicates with the central database storage 615 of the central repository 660. The central repository 660 returns publication information to the user 670 in response to the user's request.

That is, the system continues to step 615 and fulfills the request of the client by providing the desired template. The user 670 may indicate a desired template to be retrieved in a variety of ways. For example, a desired template may be ordered and retrieved based on the title of the publication. Alternatively, groups of templates may be assembled based on publications offered by a specific publisher or group of publishers. Alternatively, groups of templates may be assembled based on subject matter, geographical extent, audience, or any other factors.

Once the user's request has been received by the central repository 660, the template(s) indicated by the user is retrieved from the central data storage 615 and returned to the client. At step 616, the template is stored at the client, preferably within a client advertising document. Additionally, preferably the user 670 periodically accesses step 615 and verifies that the data within the application document is up-to-date by comparing the template in the document to the template stored at the central data storage 615. That is, the user 670 preferably periodically re-retrieves the template information from the central repository 660 and compares the retrieved template information with the template information stored at the user 670. If the retrieved information matches the template information stored at the user 670, no action is performed. If the retrieved information does not match the template information stored at the user 670, then the information stored at the user 670 is preferably updated to match the newly retrieved information from the central repository 660. Additionally, the user 670 is preferably notified.

The template data is preferably utilized by the user 670 to perform automatic tasks for the user 670 based on the template data. For example, the template may be used to preset trim, bleed, and page size for the user 670. Another example is that the template data may be used to automatically determine a common page size for the user in relation to several other publications that are part of the same work product. Additionally, the applications' data that is stored within the document is preferably passed on to other steps in the creation of the advertising page.

In operation, a standardized template is preferably provided to each publisher. The publisher is then responsible for entering and updating the data to be included in their particular publication information template. For example, the template may be represented in Hyper Text Markup Language (HTML), eXtensible Markup Language (XML) or Portable Document Format (PDF). The publisher then completes or updates the template by adding or changing the relevant information with regard to the publication. Several software applications are available that may be used to perform the completion or update of the publisher's template including, but not limited to, Macromedia Dreamweaver (HTML and XML), Microsoft FrontPage (HTML and XML) and Adobe Acrobat (PDF or PDF Forms).

As discussed above, the template is saved and optionally password protected by the publisher. That is, the saved template with all the correct publication information is put on a server that is widely accessible. The server may be an HTML server such as an Apache or Microsoft Internet Information Server (IIS), for example. The server may also be a publicly accessible server or it may be protected from public access.

Once the template has been saved, the publication preferably provides the location of the template to the central repository 660. For example, the location may be expressed as either Universal Resource Locator (URL) or Internet Protocol (IP) address of the template.

The template data is preferably examined periodically. For example by using a software robot or software-based intelligent software agent. In every instance where the term “software robot” is referenced, it is intended that the term software robot is also to include software-based intelligent agent. The software robot is preferably automatically provided with the location and, optionally, the password necessary to access the template. The software robot attempts to access the specified location and template file. If the file is not found, an error is generated and recorded in an error log. In addition, if the file is found but the incorrect password is passed the process fails and notification is logged. If the password is correct the template data is extracted by the software robot. The software robot is programmed to understand how to parse the data within the template. The extracted template data is examined and compared to the data currently stored in the database record by the robot. If the data has changed, or does not yet exist, the data is created or updated in the central database. If the data has not changed, the software robot is provided with the next location and the process begins again. When a cycle has been completed (all locations examined and compared to the stored data in the database, data updated, etc.) the software robot returns to an idle state and prepares for the time to re-examine the template data.

The user request for data may use any of several methods including but not limited to a direct database query and various forms of client modules that indirectly query the database. The central database returns the requested publication information to the client.

As mentioned above, template data may be stored at the client user 670 in a variety of ways. For example, if the client is requesting publication information utilizing a software client from within an application, the publication data information is preferably stored within the client application document. Periodically, the client within the application accesses the central data storage and verifies that the data within the application document is up-to-date with the central data storage. If the data has changed, the client data is notified and the application document is updated to match the data found in the central data storage.

The publication information may be utilized within the document to perform automatic tasks for the user based on the system data. For example, the data may be used to preset trim, bleed, and page size for the user. Another example is that the data may be used to automatically determine a common page size for the user in relation to several other publications that are a part of the same work product. The application document data that is stored within the document is preferably passed on to other steps in the creation of the advertising page. Throughout the process, the system preferably continues to monitor and query the central database storage and compare the document stored information to the central database storage. If a change in the template is detected, the user is notified and the data stored within the document is updated to match the database information.

An alternative configuration allows the processes covered in steps 609, 610, 611, 619, 612, 613, 614, 617, 618 and 619 to reside at the physical location of step 604 and for the process to remotely report data from the physical local computer system to the central repository 660. That is, whenever a template is updated by a publisher 650, a copy of the template may be automatically sent to the central repository 660 for storage. As before, the template may be later retrieved from the central repository 660 by the user 670. In this embodiment, the central repository 660 need not query the publisher 650 because all updates in a template are automatically sent to the central repository 660.

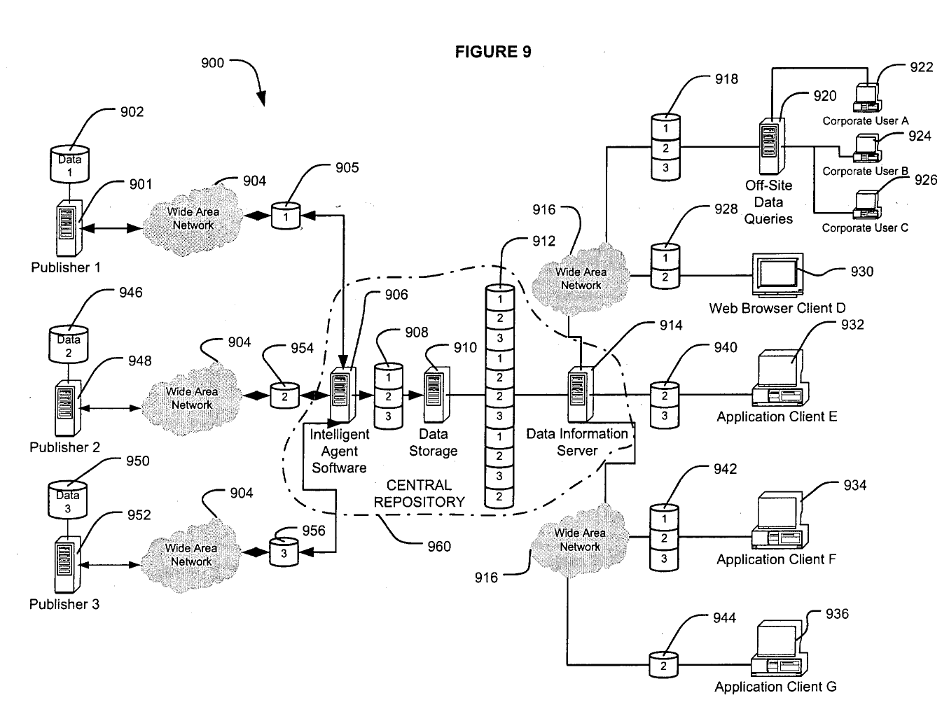

FIG. 9 depicts a network hardware diagram 900 of the publication advertisement specification management system of FIG. 6. The network hardware diagram includes three publishers, a central repository 960, and several users/clients. The users/clients include corporate user A 922, corporate user B 924, corporate user C 926, web browser client D 930, application client E 932, application client F, 934, and application client G 936. The operation of the network hardware diagram 900 is similar to that of the system of FIG. 600, but three publishers and several clients have been illustrated to provide more insight into the operation of the present invention.

As described above with reference to FIG. 6, each publisher creates a template including advertising specifications for advertising to be included in the publisher's publication. As illustrated in FIG. 9, each publisher creates its own template. The templates are expressed as data 1 902, data 2 946 and data 3 950. The template data is then stored on a server 901, 948, and 952 at each respective publisher. The servers 901, 948, 952 are connected to the central repository 960 by a wide area network 904 or other connection such as the internet.

As discussed with regard to FIG. 6 above, periodically, the central repository 960 queries the servers 901, 948, 952 at the publishers. If the template data 902, 946, 952 has been updated, the new template data is retrieved by the central repository 960. FIG. 9 illustrated the situation wherein each publisher's template data has been updated. Consequently, a copy of the updated data 905, 954, 956 is being retrieved by the central repository 960.

As shown in FIG. 9, the central repository 960 includes a server 906 implementing an intelligent software agent, as well as data storage 910 and a data information server 914. As discussed above, the intelligent software agent accesses the publisher's servers 901, 948, 952 and compares the data 902, 946, 950 on the servers to the data stored in the data storage 910. If the data stored in the data storage 910 matches the data 902, 946, 950 from the publisher's servers, no action takes place. However, if the data stored in the data storage 910 does not match the data 902, 946, 950 from the publisher's servers, the new data from the publisher's servers is retrieved by the intelligent software agent 906.

Once the intelligent software agent 906 retrieves the new data 902, 946, 950, the intelligent software agent preferably parses the data 902, 946, 950 to place the data into a data base format 908. Once the retrieved data has been placed in the preferred database format 908, the data is stored in the data storage 910.

At the data information server 914 of the central repository 960, many clients/users 922, 924, 926, 930, 932, 934, 936 may access the template data stored in the data storage 910. The data information server 914 mediates the requests of the various clients/users 922, 924, 926, 930, 932, 934, 936 to deliver the desired template data to each of the clients/users 922, 924, 926, 930, 932, 934, 936. Each of the clients/users 922, 924, 926, 930, 932, 934, 936 communicated with the data information server 914 through a wide area network 916 or other connection such as the internet. Alternatively, the data information 914 may be directly connected to a client as illustrated with regard to application client E 932.

As illustrated in FIG. 9, once the data information server 914 receives requests from the clients/users 922, 924, 926, 930, 932, 934, 936, the data information server 914 queries the data storage 910. Preferably, the data storage 910 constructs copies of the template data records as needed by the data information server 914 and packages the template data record copies 912 for transmission to the data information server 914. The data information server 914 then preferably segments the received template data record copies 912 and transmits the template data to the requesting clients/users 922, 924, 926, 930, 932, 934, 936. Each of the clients/users 922, 924, 926, 930, 932, 934, 936 may be requesting template data for one or more publication.

The template data may have been requested by the clients/users 922, 924, 926, 930, 932, 934, 936 for a variety of uses. For example, application clients E-G 932, 934, 936 illustrate the direct importation of the template data into an application. For example, the application may be any of a number of graphics programs such as Adobe Illustrator, Adobe Photoshop, QuarkXPress, etc. The template data may directly interact with a macro or other application setting within the application to directly provide a template for the user. For example, the macro may prevent a user from resizing an illustration out of the proper range specified by the template. If the user attempted such resizing, the macro may provide a warning to the user and block the operation. Additionally, the macro may allow the user direct access to the template so that the user may know the constraints of the publication. For example, the template may be expressed in words or graphically.

Application client G 936 illustrates the retrieval of a single publication specification 944 from the central repository 960 over the communication network 916. Application client F illustrates the retrieval of multiple publication specification templates 942 from the central repository 960 over the communication network 916. Application client E illustrates the retrieval of multiple templates 940 directly from the central repository 960.

Web browser client 930 illustrates a situation in which the templates 928 are not directly incorporated into an application as with application clients E-F 932, 934, 936. Instead, the template is accessed and displayed using a web browser. As with the display to the user through the application described above, the display via the browser may be graphical, textual, or both.

Corporate Users A-C 922, 924, 926 illustrate a situation in which a separate server 920 for off-site data queries has been used. That is, instead of each of the corporate users A-C 922, 924, 926 retrieving templates from the central repository 960, copies 918 of all of the templates stored in the central repository are periodically sent to the off-site server 920 and stored at an off-site server. The corporate users A-C 922, 924, 926 may then query the off-site server when template information is needed. Alternatively, the off-site server 920 may be a mirror server of the central repository 960. Thus, whenever a template is updated at the central repository, the template is immediately updated at the off-site server 920.

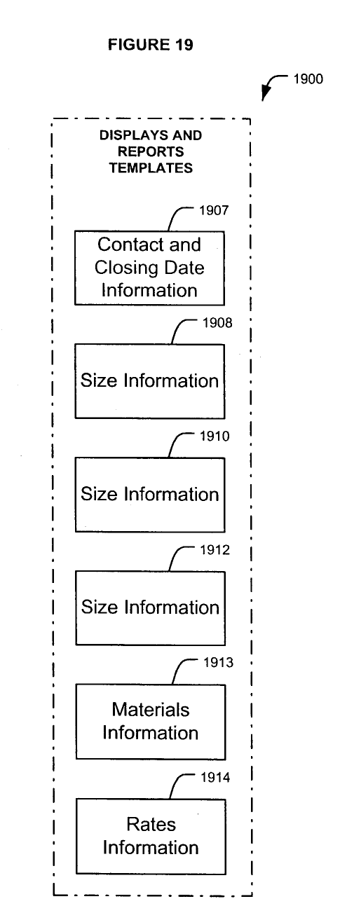

FIG. 19 illustrates an exemplary template 1900 for use with the publication advertisement specification management system of the present invention. The exemplary template 1990 is logically partitioned into a number of data sections including: a contact and closing date information section 1907, a first size information section 1908, a second size information section 1910, a third size information section 1912, a materials information section 1913, and a rates information section 1914. As appreciated by those of skill in the art, the exemplary template 1900 is not limited to the illustrated sections, nor is any section essential to the operation of the template.

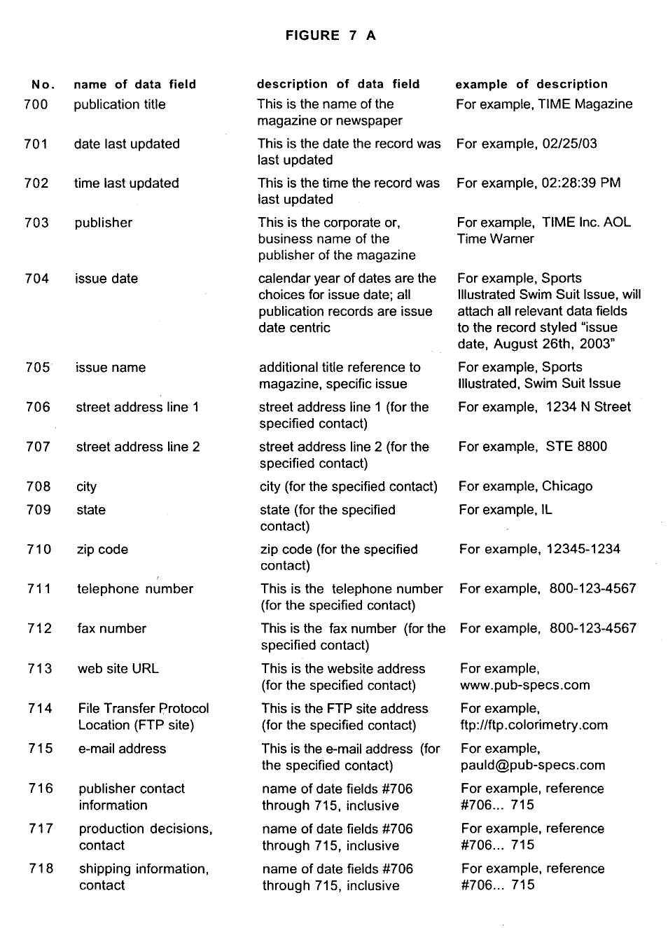

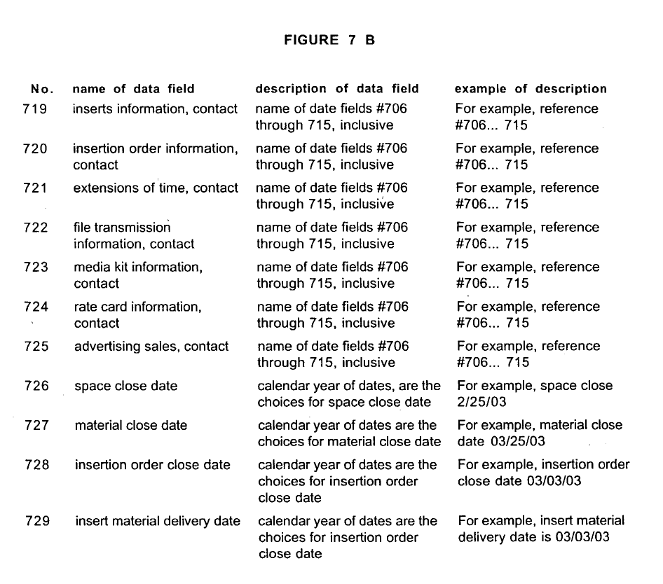

The contact and closing date information section 1907 preferably includes information to allow those accessing the template to communicate directly with the publisher using phone or mail, for example. The contact and closing date information section 1907 also preferably includes information such as the date the template 1900 became effective and any expiration date for the template 1900. The exemplary contact and closing date information section 1907 is further illustrated below with reference to FIGS. 7A-B.

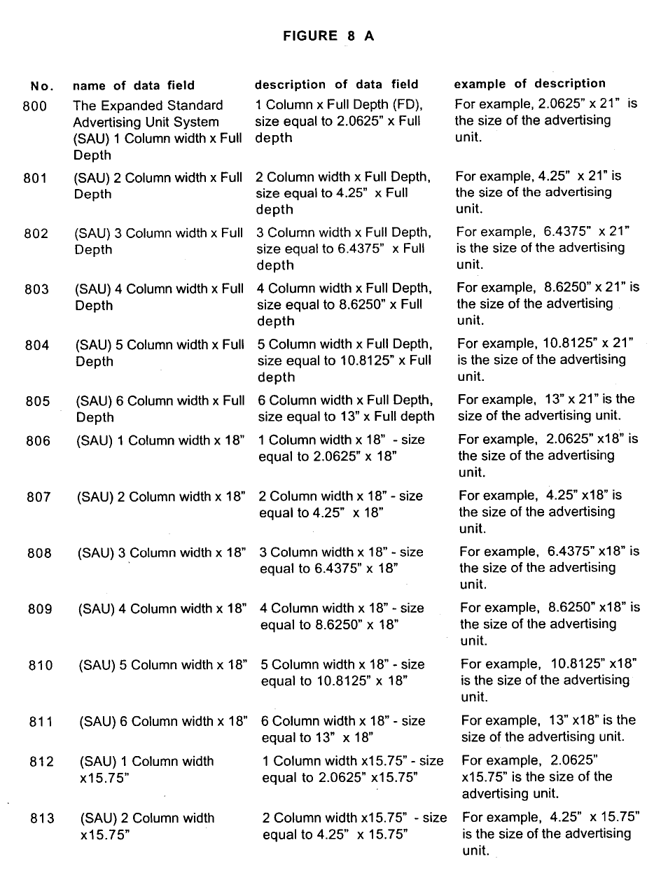

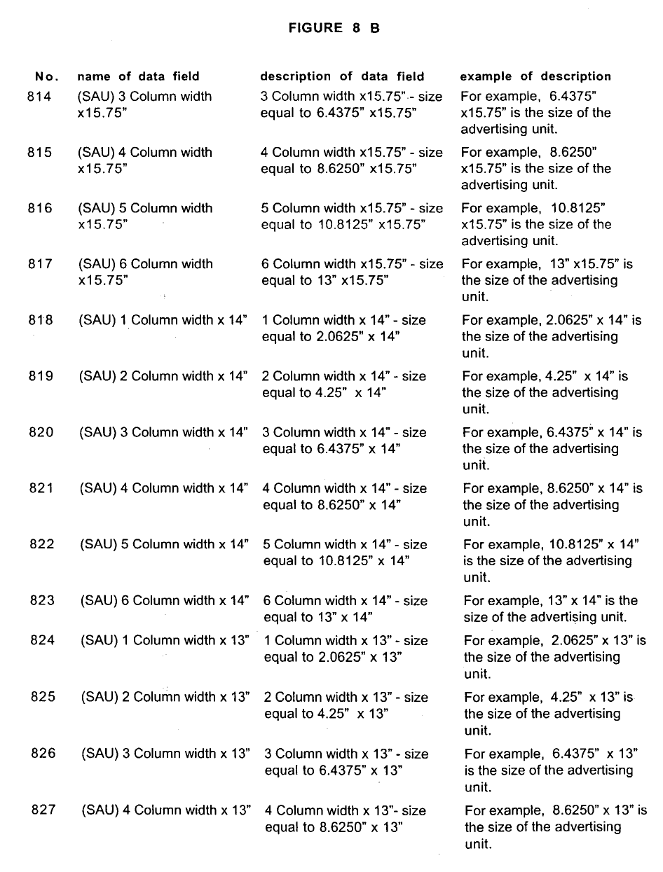

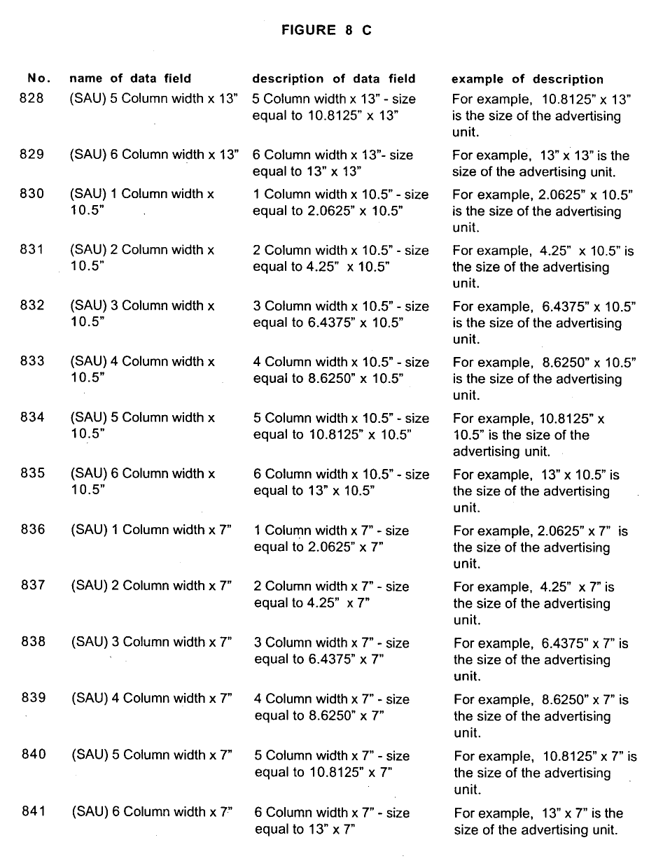

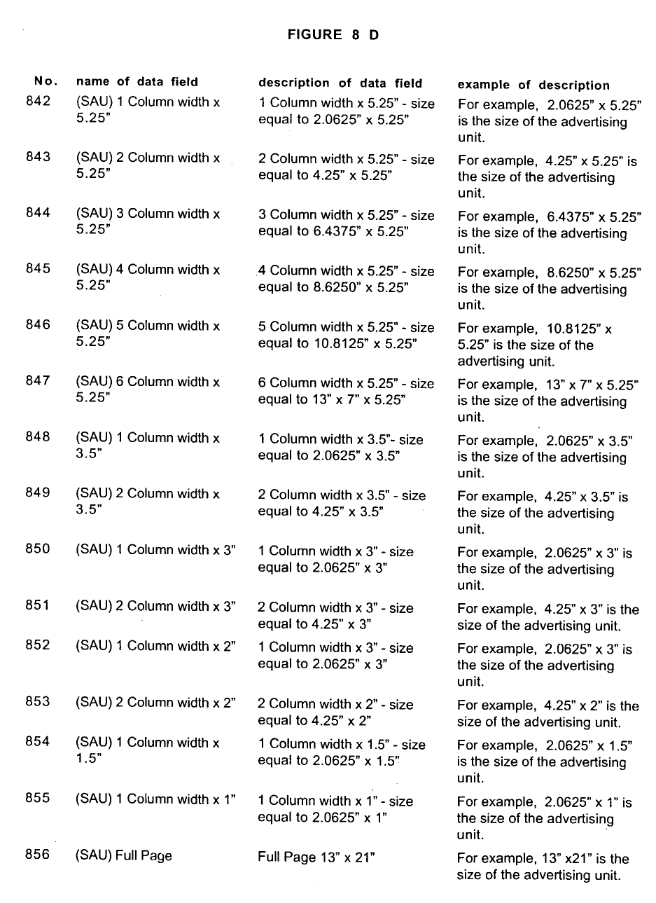

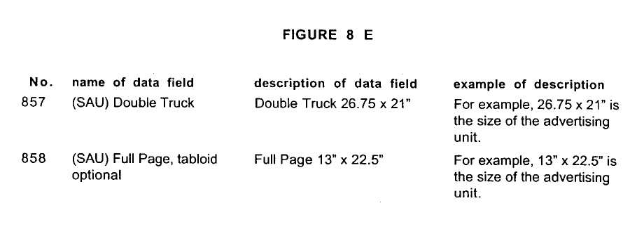

The first size information section 1908 preferably includes sizing information relating to a first set of industry standards. As mentioned above, several sets of industry standards may be utilized by publishers to express the sizing and other limitations for advertisements to be included in their publications. The exemplary template 1900 preferably has several size information sections 1908-1912 so as to preferably accommodate as many industry standards as possible. The first size information section 1908 illustrates an exemplary template set for the Expanded Standard Advertising Unit System (SAU) standard for newspaper advertisements. The first size information section 1908 includes various sizing parameters as further illustrated below with reference to FIGS. 8A-E.

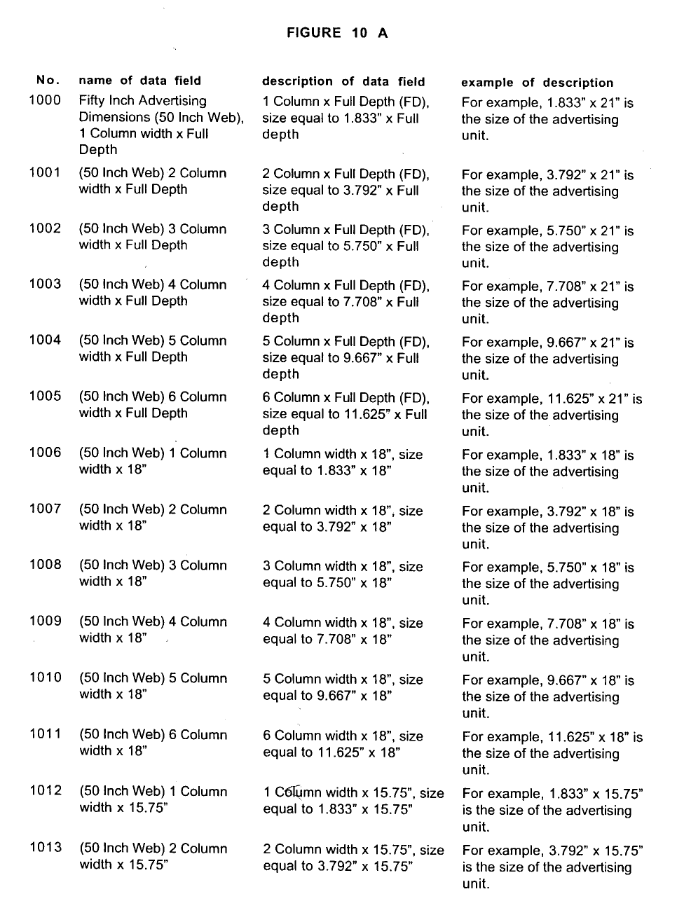

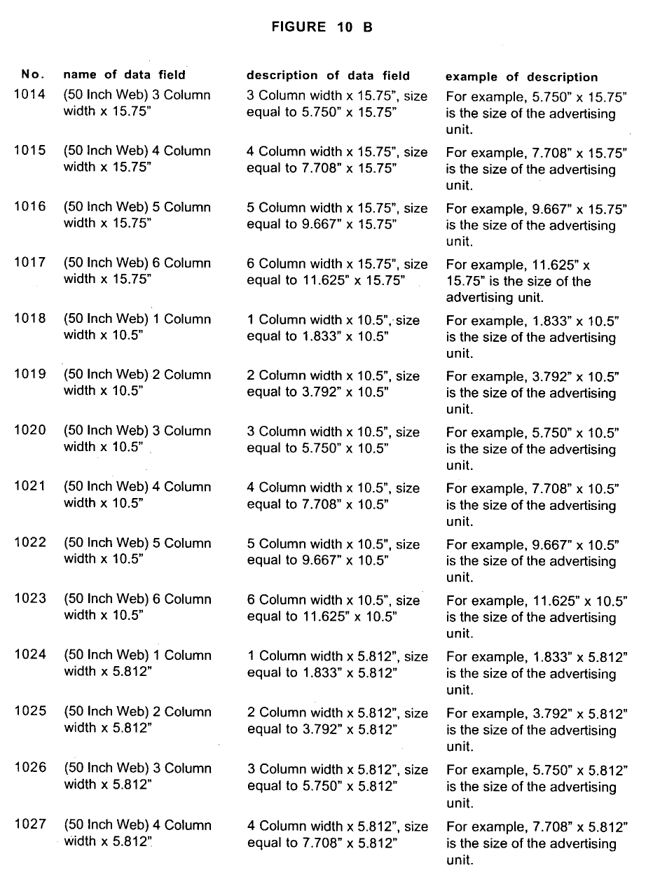

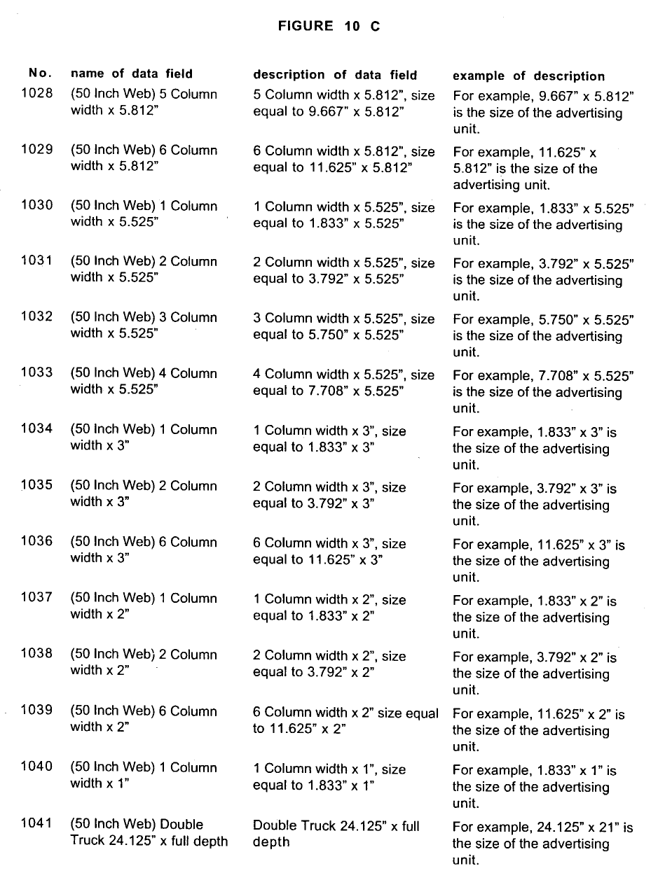

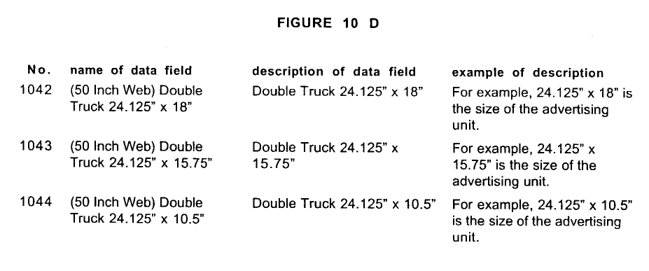

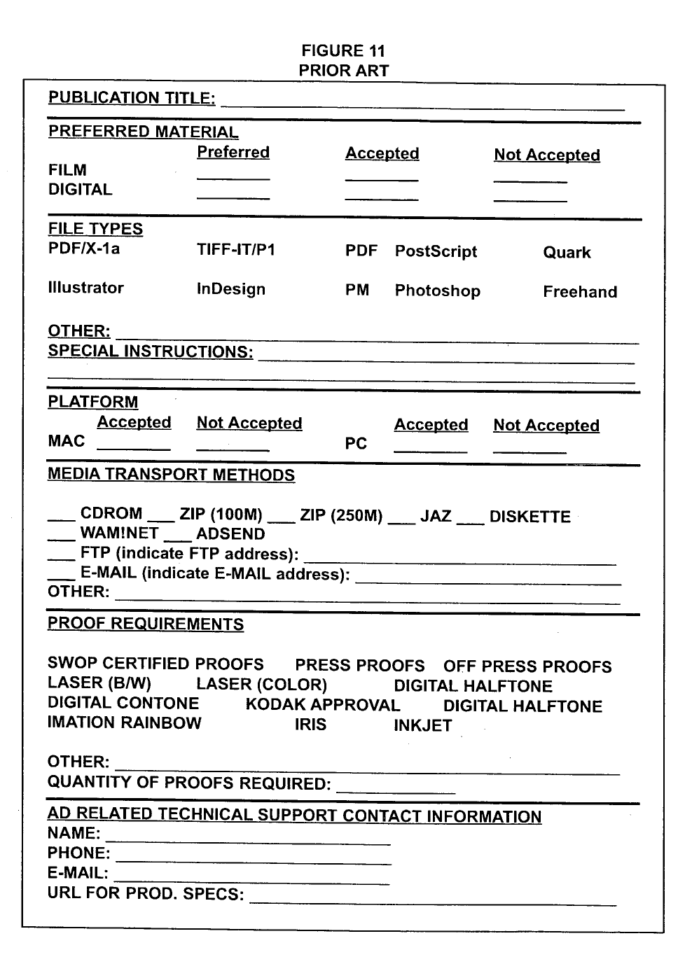

The second size information section 1910 is similar to the first size information section 1908, but is directed toward a different set of standards, specifically the set of standards encompassing Fifty Inch Advertising Dimensions for Newspaper Advertisements. The second size information section 1910 includes various sizing parameters as further illustrated below with reference to FIGS. 10A-D.

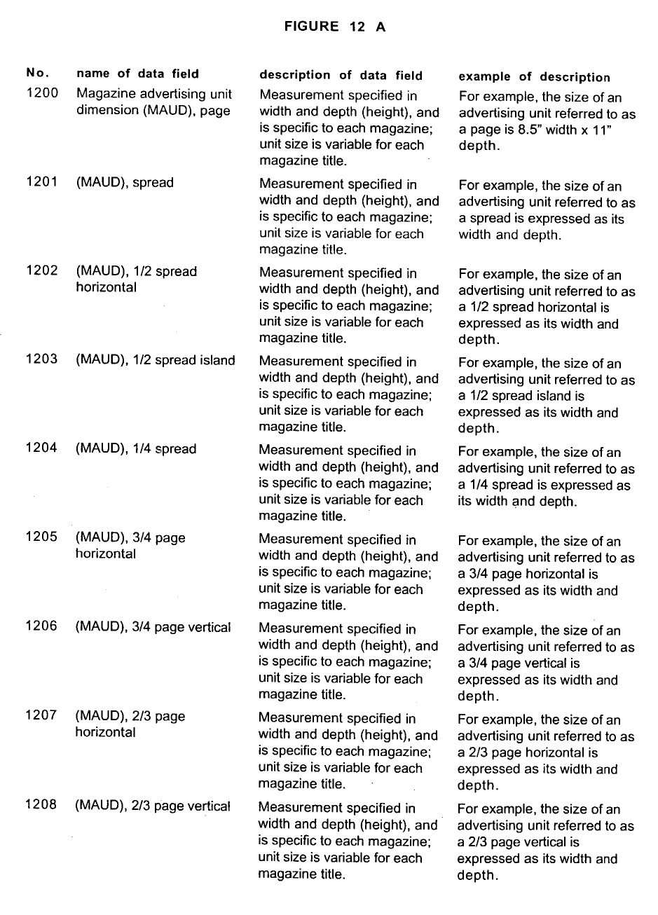

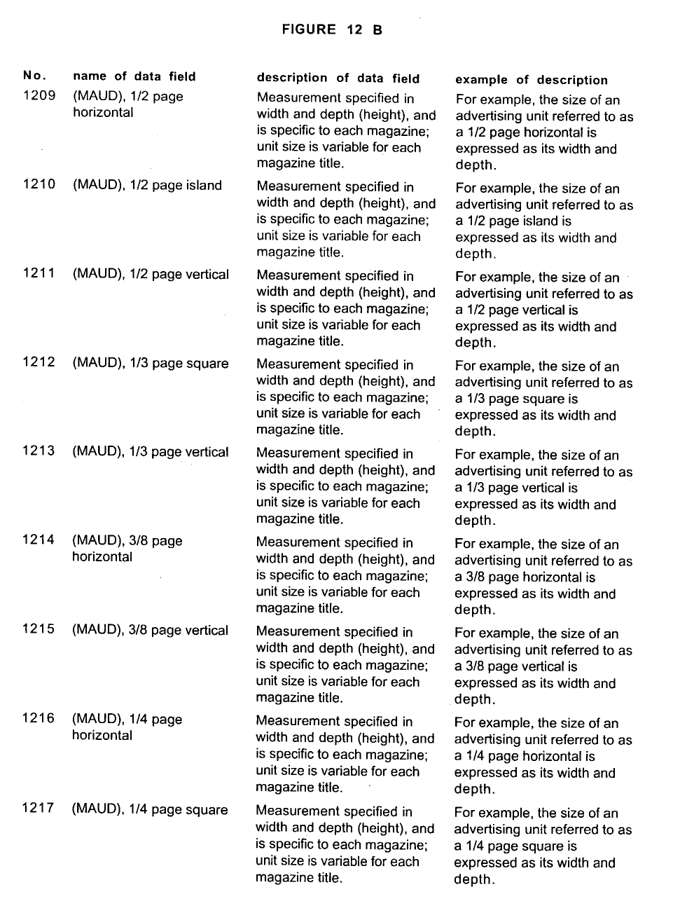

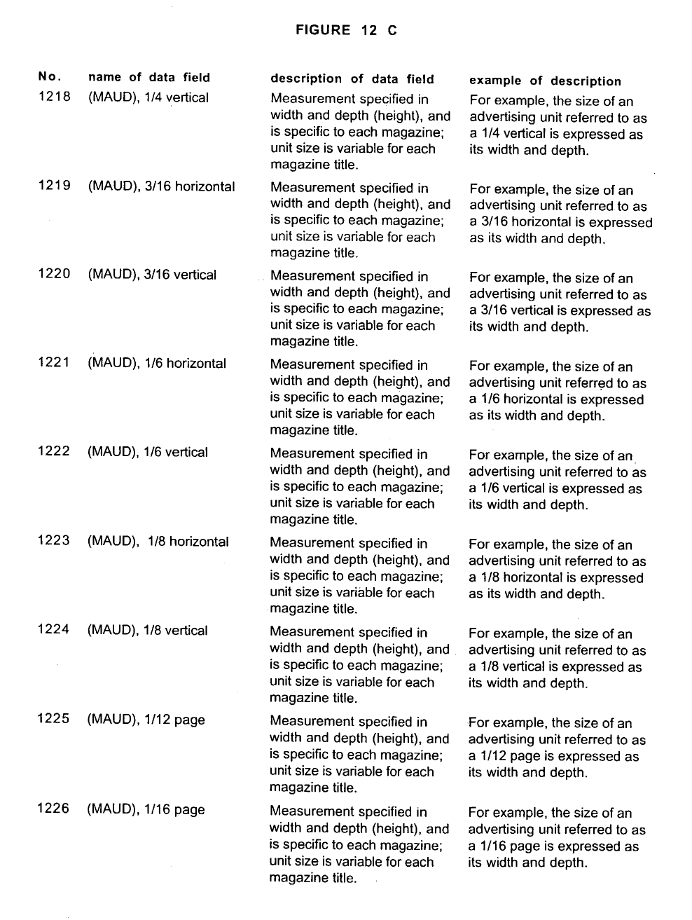

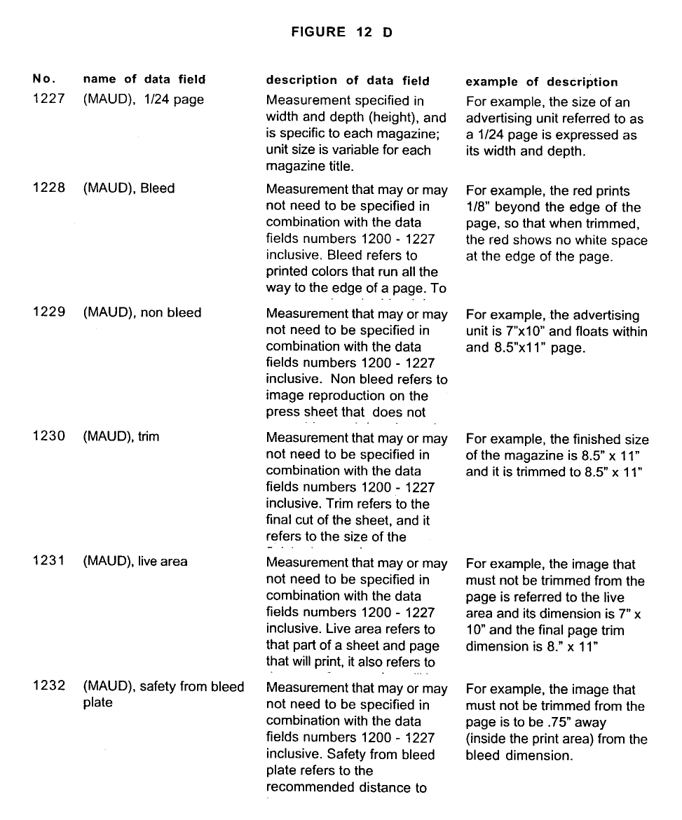

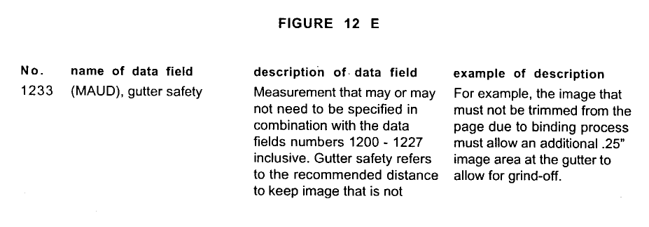

The third size information section 1912 is also similar to the first and second size information section 1908-1910, but is directed toward a different set of standards, specifically the set of standards encompassing Magazine Advertising Units Dimensions (MAUD). The third size information section 1912 includes various sizing parameters as further illustrated below with reference to FIGS. 12A-E.

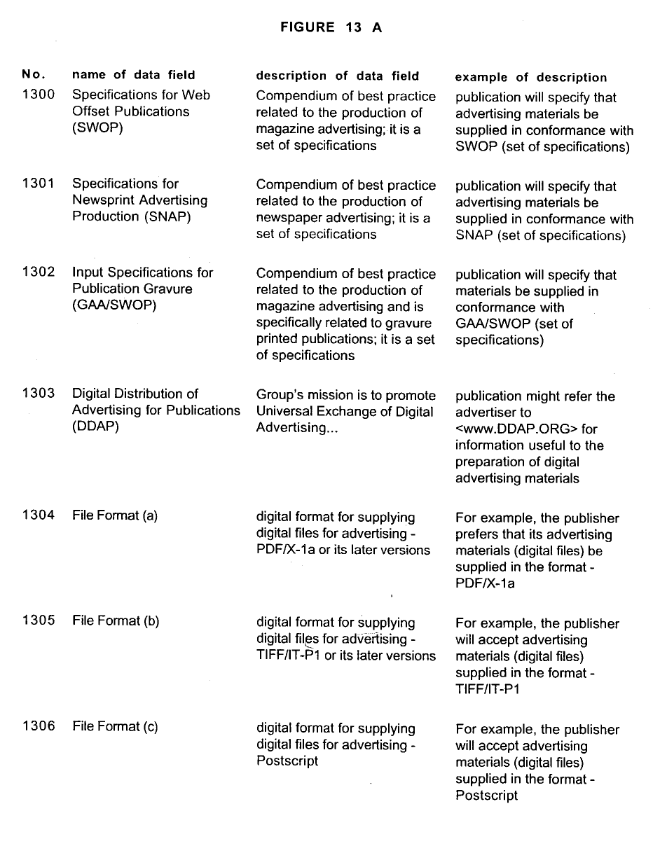

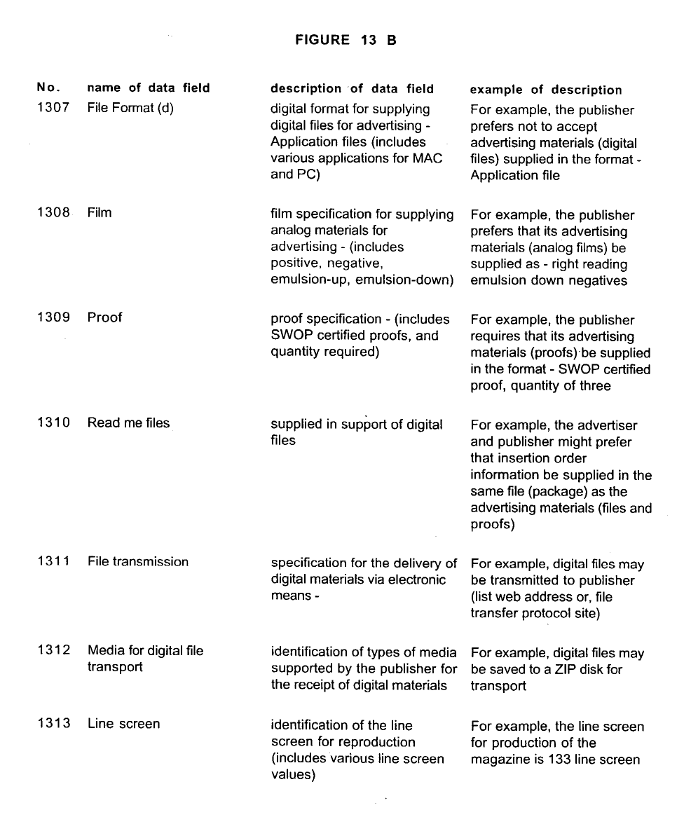

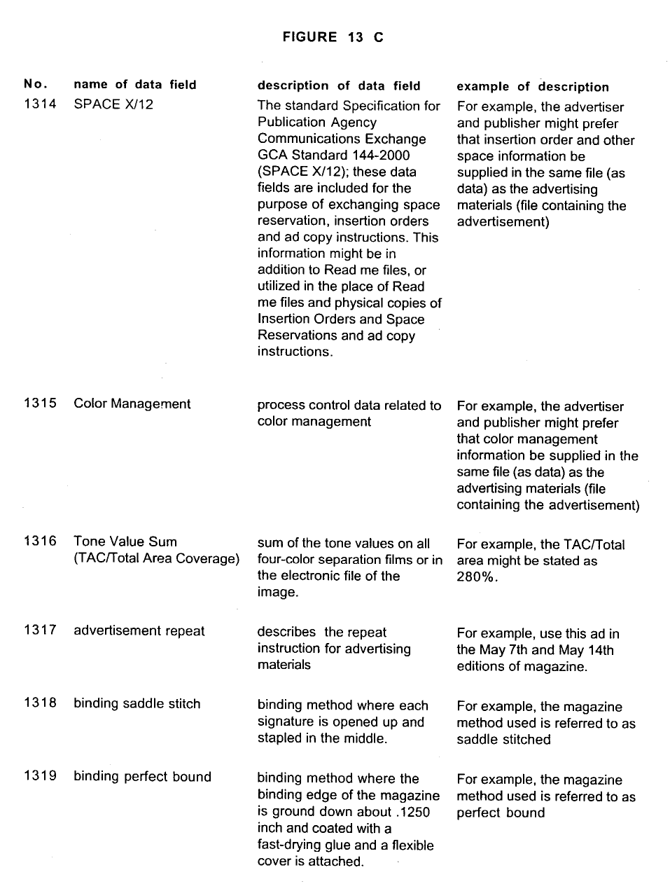

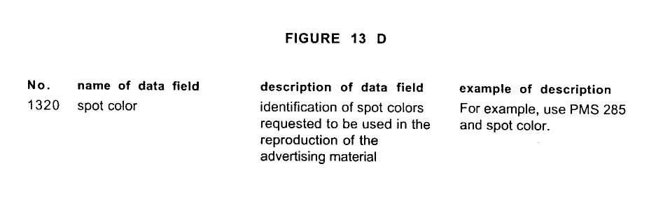

The materials information section 1913 preferably includes information regarding file or media format and color management. The materials information section 1913 preferably includes various parameters as further illustrated below with reference to FIGS. 13A-D.

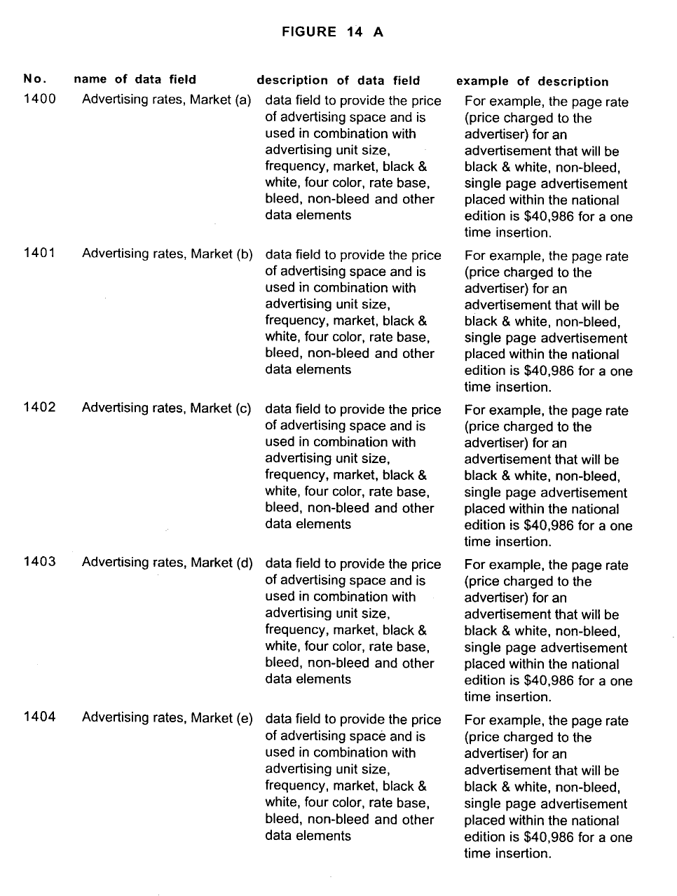

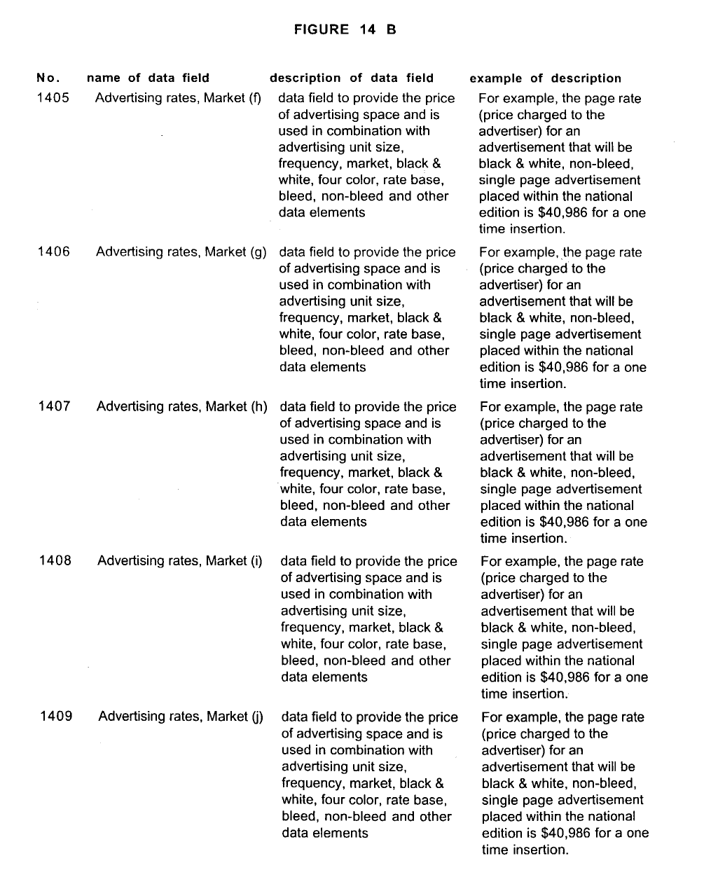

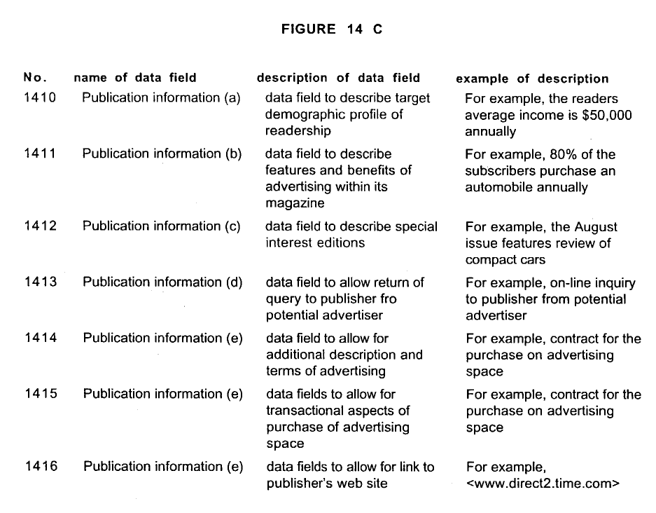

The rates information section 1914 preferably includes information regarding advertisement costing for specific publications or groups of publications. The rates information section 1914 may also include more detailed rate information regarding various options for display of an advertisement (multi-color, mono color, black and white) or rate promotions being offered by a publisher. Information in the rates information section 1914 may not be limited to information for a single publication and may provide rate information based on various groupings of publications such as combined rates for all publications by a publisher and rates for groups of publications aimed a specific demographic or other interest. The rates information section 1914 preferably includes various parameters as further illustrated below with reference to FIGS. 14A-C.

FIGS. 7A-B illustrate an exemplary contact and closing date information section 1907 of the publisher's template 1900 of FIG. 19. The exemplary contact and closing date information section 1907 preferably includes: 700 PUBLICATION TITLE, 701 DATE LAST UPDATED, 702 TIME LAST UPDATED, 703 PUBLISHER, 704 ISSUE DATE, 705 ISSUE NAME, 706 STREET ADDRESS LINE 1, 707 STREET ADDRESS LINE 2, 708 CITY, 709 STATE, 710 ZIP CODE, 711 TELEPHONE NUMBER, 712 FAX NUMBER, 713 WEB SITE URL, 714 FILE TRANSFER PROTOCOL LOCATION (FTP SITE), 715 E-MAIL ADDRESS, 716 PUBLISHER CONTACT INFORMATION, 717 PRODUCTION DECISIONS CONTACT, 718 SHIPPING INFORMATION CONTACT, 719 INSERTS INFORMATION CONTACT, 720 INSERTION ORDER INFORMATION CONTACT, 721 EXTENSIONS OF TIME CONTACT, 722 FILE TRANSMISSION INFORMATION CONTACT, 723 MEDIA KIT INFORMATION CONTACT, 724 RATE CARD INFORMATION CONTACT, 725 ADVERTISING SALES CONTACT, 726 SPACE CLOSE DATE, 727 MATERIAL CLOSE DATE, 728 INSERTION ORDER CLOSE DATE, 729 INSERT MATERIAL DELIVERY DATE.

FIGS. 8A-E illustrate an exemplary first size information section 1908 of the publisher's template 1900 of FIG. 19. The first size information section 1908 is preferably devoted to the Expanded Standard Advertising Unit System (SAU) for newspaper advertisements. The exemplary first size information section 1908 preferably includes: 800 THE EXPANDED STANDARD ADVERTISING UNIT SYSTEM (SAU) 1 COLUMN WIDTH×FULL DEPTH, 801 (SAU) 2 COLUMN WIDTH×FULL DEPTH, 802 (SAU) 3 COLUMN WIDTH×FULL DEPTH, 803 (SAU) 4 COLUMN WIDTH×FULL DEPTH, 804 (SAU) 5 COLUMN WIDTH×FULL DEPTH, 805 (SAU) 6 COLUMN WIDTH×FULL DEPTH, 806 (SAU) 1 COLUMN WIDTH×18, 807 (SAU) 2 COLUMN WIDTH×18, 808, (SAU) 3 COLUMN WIDTH×18, 809 (SAU) 4 COLUMN WIDTH×18, 810 (SAU) 5 COLUMN WIDTH×18, 811 (SAU) 6 COLUMN WIDTH×18, 812 (SAU) 1 COLUMN WIDTH×15.75, 813 (SAU) 2 COLUMN WIDTH×15.75, 814 (SAU) 3 COLUMN WIDTH ×15.75, 815 (SAU) 4 COLUMN WIDTH×15.75, 816 (SAU) 5 COLUMN WIDTH×15.75, 817 (SAU) 6 COLUMN WIDTH×15.75, 818 (SAU) 1 COLUMN WIDTH×14, 819 (SAU) 2 COLUMN WIDTH×14, 820 (SAU) 3 COLUMN WIDTH×14, 821 (SAU) 4 COLUMN WIDTH×14, 822 (SAU) 5 COLUMN WIDTH×14, 823 (SAU) 6 COLUMN WIDTH×14, 824 (SAU) 1 COLUMN WIDTH×13, 825 (SAU) 2 COLUMN WIDTH×13, 826 (SAU) 3 COLUMN WIDTH×13, 827 (SAU) 4 COLUMN WIDTH×13, 828 (SAU) 5 COLUMN WIDTH×13, 829 (SAU) 6 COLUMN WIDTH×13, 830 (SAU) 1 COLUMN WIDTH×10.5, 831 (SAU) 2 COLUMN WIDTH×10.5, 832 (SAU) 3 COLUMN WIDTH×10.5, 833 (SAU) 4 COLUMN WIDTH×10.5, 834 (SAU) 5 COLUMN WIDTH×10.5, 835 (SAU) 6 COLUMN WIDTH×10.5, 836 (SAU) 1 COLUMN WIDTH×7, 837 (SAU) 2 COLUMN WIDTH×7, 838 (SAU) 3 COLUMN WIDTH×7, 839 (SAU) 4 COLUMN WIDTH×7, 840 (SAU) 5 COLUMN WIDTH×7, 841 (SAU) 6 COLUMN WIDTH×7, 842 (SAU) 1 COLUMN WIDTH×5.25, 843 (SAU) 2 COLUMN WIDTH×5.25, 844 (SAU) 3 COLUMN WIDTH×5.25, 845 (SAU) 4 COLUMN WIDTH×5.25, 846 (SAU) 5 COLUMN WIDTH×5.25, 847 (SAU) 6 COLUMN WIDTH×5.25, 848 (SAU) 1 COLUMN WIDTH×3.5, 849 (SAU) 2 COLUMN WIDTH×3.5, 850 (SAU) 1 COLUMN WIDTH×3, 851 (SAU) 2 COLUMN WIDTH×3, 852 (SAU) 1 COLUMN WIDTH×2, 853 (SAU) 2 COLUMN WIDTH×2, 854 (SAU) 1 COLUMN WIDTH×1.5, 855 (SAU) 1 COLUMN WIDTH×1, 856 (SAU) FULL PAGE, 857 (SAU) DOUBLE TRUCK and 858 (SAU) FULL PAGE; TABLOID OPTIONAL.

FIGS. 10A-D illustrate an exemplary second size information section 1910 of the publisher's template 1900 of FIG. 19. The second size information section 1910 is preferably devoted to the Fifty Inch Advertising Dimensions for newspaper advertisements. The exemplary second size information section 1910 preferably includes: 1000 FIFTY INCH ADVERTISING DIMENSIONS (50 INCH WEB), 1 COLUMN WIDTH×FULL DEPTH, 1001 (50 INCH WEB) 2 COLUMN WIDTH×FULL DEPTH, 1002 (50 INCH WEB) 3 COLUMN WIDTH×FULL DEPTH, 1003 (50 INCH WEB) 4 COLUMN WIDTH×FULL DEPTH, 1004 (50 INCH WEB) 5 COLUMN WIDTH×FULL DEPTH, 1005 (50 INCH WEB) 6 COLUMN WIDTH×FULL DEPTH, 1006 (50 INCH WEB) 1 COLUMN WIDTH×18, 1007 (50 INCH WEB) 2 COLUMN WIDTH×18, 1008 (50 INCH WEB) 3 COLUMN WIDTH×18, 1009 (50 INCH WEB) 4 COLUMN WIDTH×18, 1010 (50 INCH WEB) 5 COLUMN WIDTH×18, 1011 (50 INCH WEB) 6 COLUMN WIDTH×18, 1012 (50 INCH WEB) 1 COLUMN WIDTH×15.75, 1013 (50 INCH WEB) 2 COLUMN WIDTH×15.75, 1014 (50 INCH WEB) 3 COLUMN WIDTH×15.75, 1015 (50 INCH WEB) 4 COLUMN WIDTH×15.75, 1016 (50 INCH WEB) 5 COLUMN WIDTH×15.75, 1017 (50 INCH WEB) 6 COLUMN WIDTH×15.75, 1018 (50 INCH WEB) 1 COLUMN WIDTH×10.5, 1019 (50 INCH WEB) 2 COLUMN WIDTH×10.5, 1020 (50 INCH WEB) 3 COLUMN WIDTH×10.5, 1021 (50 INCH WEB) 4 COLUMN WIDTH×10.5, 1022 (50 INCH WEB) 5 COLUMN WIDTH×10.5, 1023 (50 INCH WEB) 6 COLUMN WIDTH×10.5, 1024 (50 INCH WEB) 1 COLUMN WIDTH×5.812, 1025 (50 INCH WEB) 2 COLUMN WIDTH×5.812, 1026 (50 INCH WEB) 3 COLUMN WIDTH×5.812, 1027 (50 INCH WEB) 4 COLUMN WIDTH×5.812, 1028, (50 INCH WEB) 5 COLUMN WIDTH×5.812, 1029 (50 INCH WEB) 6 COLUMN WIDTH×5.812, 1030 (50 INCH WEB) 1 COLUMN WIDTH×5.525, 1031 (50 INCH WEB) 2 COLUMN WIDTH×5.525, 1032 (50 INCH WEB) 3 COLUMN WIDTH×5.525, 1033 (50 INCH WEB) 4 COLUMN WIDTH×5.525, 1034 (50 INCH WEB) 1 COLUMN WIDTH×3, 1035 (50 INCH WEB) 2 COLUMN WIDTH×3, 1036 (50 INCH WEB) 6 COLUMN WIDTH×3, 1037 (50 INCH WEB) 1 COLUMN WIDTH×2, 1038 (50 INCH WEB) 2 COLUMN WIDTH×2, 1039 (50 INCH WEB) 6 COLUMN WIDTH×2, 1040 (50 INCH WEB) 1 COLUMN WIDTH×1, 1041 (50 INCH WEB) DOUBLE TRUCK 24.125×FULL DEPTH, 1042 (50 INCH WEB) DOUBLE TRUCK 24.125×18, 1043 (50 INCH WEB) DOUBLE TRUCK 24.125×15.75, 1044 (50 INCH WEB) DOUBLE TRUCK 24.125×10.5.

FIGS. 12A-E illustrate an exemplary third size information section 1912 of the publisher's template 1900 of FIG. 19. The third size information section 1912 is preferably devoted to the Magazine Advertising Units Dimensions (MAUD). The exemplary third size information section 1912 preferably includes: 1200 MAGAZINE ADVERTISING UNIT DIMENSION (MAUD) PAGE, 1201 (MAUD) SPREAD, 1202 (MAUD) ½ SPREAD HORIZONTAL, 1203 (MAUD) ½ SPREAD ISLAND, 1204 (MAUD) ¼ SPREAD, 1205 (MAUD) ¾ PAGE HORIZONTAL, 1206 (MAUD) ¾ PAGE VERTICAL, 1207 (MAUD) ⅔ PAGE HORIZONTAL, 1208 (MAUD) ⅔ PAGE VERTICAL, 1209 (MAUD) ½ PAGE HORIZONTAL, 1210 (MAUD) ½ PAGE ISLAND, 1211 (MAUD) ½ PAGE VERTICAL, 1212 (MAUD) ⅓ PAGE SQUARE, 1213 (MAUD) ⅓ PAGE VERTICAL, 1214 (MAUD) ⅜ PAGE HORIZONTAL, 1215 (MAUD) ⅜ PAGE VERTICAL, 1216 (MAUD) ¼ PAGE HORIZONTAL, 1217 (MAUD) ¼ PAGE SQUARE, 1218 (MAUD) ¼ VERTICAL, 1219 (MAUD) 3/16 HORIZONTAL, 1220 (MAUD) 3/16 VERTICAL, 1221 (MAUD) ⅙ HORIZONTAL, 1222 (MAUD) ⅙ VERTICAL, 1223 (MAUD) ⅛ HORIZONTAL, 1224 (MAUD) ⅛ VERTICAL, 1225 (MAUD) 1/12 PAGE, 1226 (MAUD) 1/16 PAGE, 1227 (MAUD), 1/24 PAGE, 1228 (MAUD) BLEED, 1229 (MAUD) NON BLEED, 1230 (MAUD) TRIM, 1231 (MAUD) LIVE AREA, 1232 (MAUD) SAFETY FROM BLEED PLATE, 1233 (MAUD) GUTTER SAFETY.

FIGS. 13A-D illustrate an exemplary materials information section 1913 of the publisher's template 1900 of FIG. 19. The exemplary materials information section 1913 preferably includes: 1300 SPECIFICATIONS FOR WEB OFFSET PUBLICATIONS (SWOP), 1301 SPECIFICATIONS FOR NEWSPRINT ADVERTISING PRODUCTION (SNAP), 1302 INPUT SPECIFICATIONS FOR PUBLICATION GRAVURE (GAA/SWOP), 1303 DIGITAL DISTRIBUTION OF ADVERTISING FOR PUBLICATIONS (DDAP), 1304 FILE FORMAT (A), 1305 FILE FORMAT (B), 1306 FILE FORMAT (C), 1307 FILE FORMAT (D), 1308 FILM, 1309 PROOF, 1310 READ ME FILES, 1311 FILE TRANSMISSION, 1312 MEDIA FOR DIGITAL FILE TRANSPORT, 1313 LINE SCREEN, 1314 SPACE X/12, 1315 COLOR MANAGEMENT, 1316 TONE VALUE SUM (TAC/TOTAL AREA COVERAGE), 1317 ADVERTISEMENT REPEAT, 1318 BINDING SADDLE STITCH, 1319 BINDING PERFECT BOUND, 1320 SPOT COLOR.

FIGS. 14A-C illustrate an exemplary rates information section 1914 of the publisher's template 1900 of FIG. 19. The exemplary rates information section 1914 preferably includes: 1400 ADVERTISING RATES MARKET (A), 1401 ADVERTISING RATES MARKET (B), 1402 ADVERTISING RATES MARKET (C), 1403 ADVERTISING RATES MARKET (D), 1404 ADVERTISING RATES MARKET (E), 1405 ADVERTISING RATES MARKET (F), 1406 ADVERTISING RATES MARKET (G), 1407 ADVERTISING RATES MARKET (H), 1408 ADVERTISING RATES MARKET (I), 1409 ADVERTISING RATES MARKET (J), 1410 PUBLICATION INFORMATION (A), 1411 PUBLICATION INFORMATION (B), 1412 PUBLICATION INFORMATION (C), 1413 PUBLICATION INFORMATION (D), 1414 PUBLICATION INFORMATION (E), 1415 PUBLICATION INFORMATION (E), 1416 PUBLICATION INFORMATION (E).

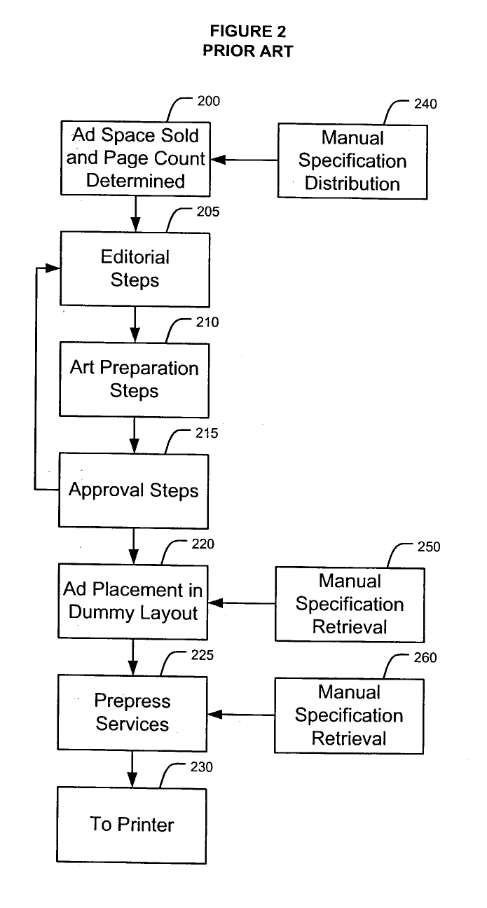

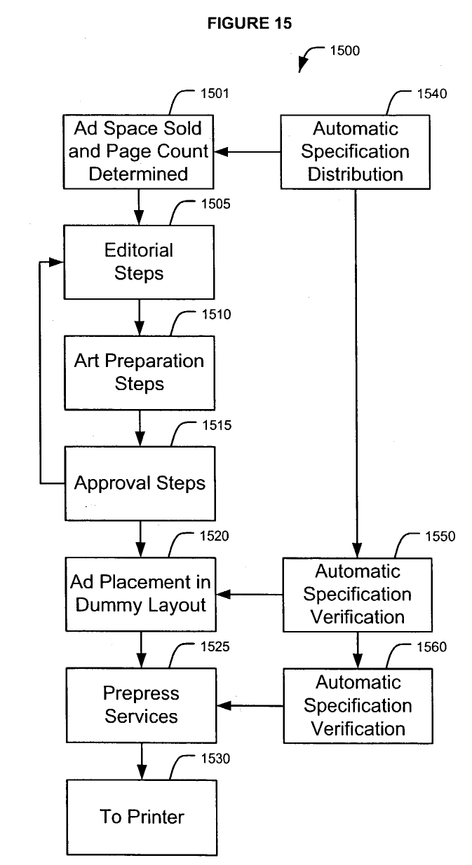

FIG. 15 is similar to FIG. 2, but shows the interaction of the automated publication specification template distribution and retrieval system with the publisher's activities. As shown by the comparison of FIG. 15 to FIG. 2, the previous manual retrieval methodology of FIG. 2 has been replaced by the automated retrieval and integration of the publication template. Thus, at step 1540, the template is developed by the publisher. However, instead of being manually distributed, the template is then automatically distributed using the above-described system. At steps 1550 and 1560, instead of performing the prior art's manual verification of publication information, the electronic files embodying the advertisement may be automatically verified to comply with the template without human interaction. Thus, a great increase in accuracy and a decrease in human work-hours may be realized.

Thus, as shown in FIG. 15, the publisher maintains publication information on the invention template preferably installed on the publisher's own web site as described above. The publisher updates the template as needed, with up-to-date and accurate information about the publication rates and specifications and other information that is pertinent to the advertiser. Using the template provided to the publisher, the publisher now has a comprehensive and well organized computer based form within which to provide pertinent information about the publication so that advertisers are well advised as to how to supply advertising materials, rates and other information.

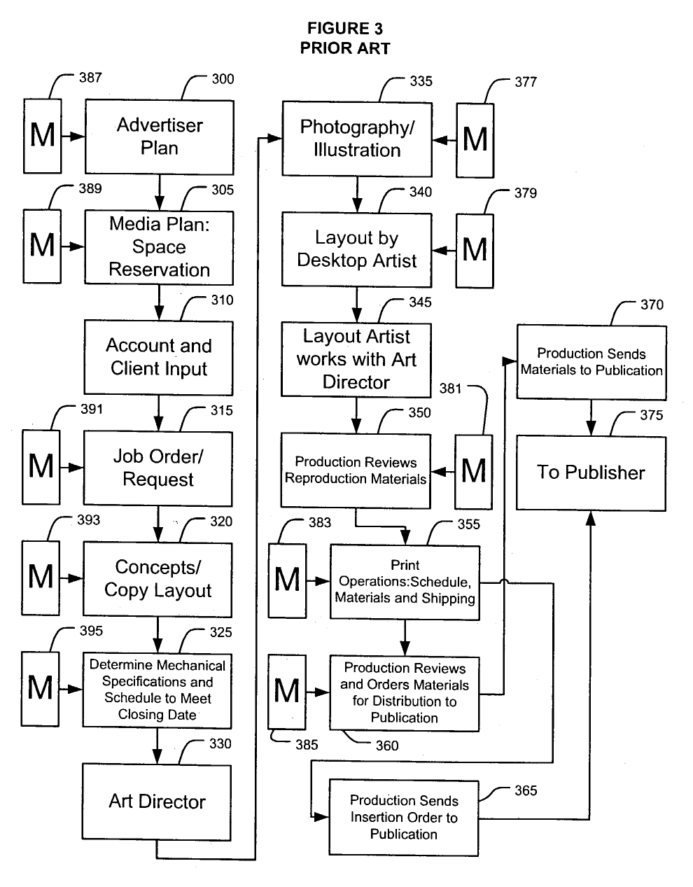

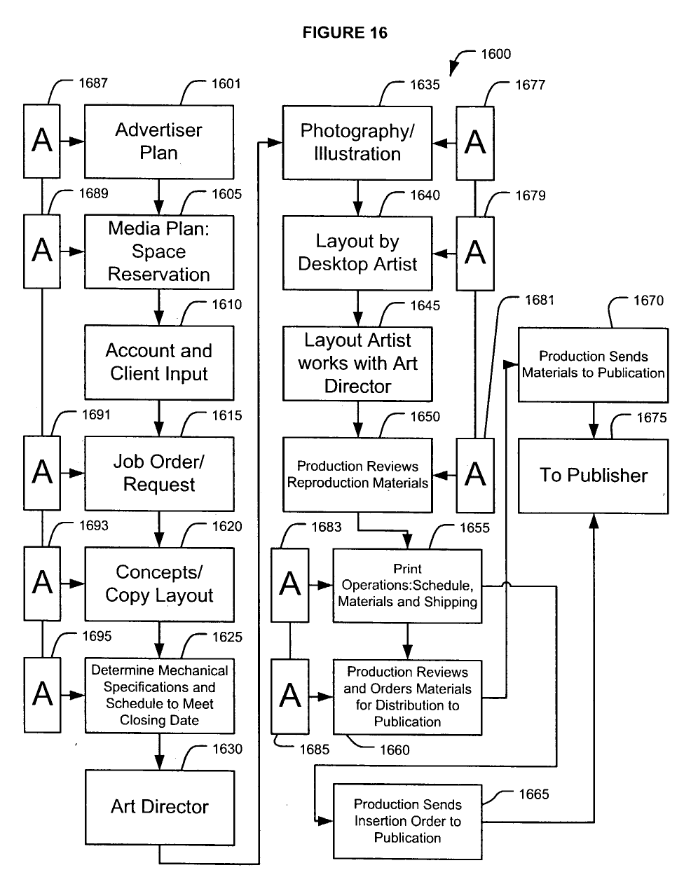

FIG. 16 is similar to FIG. 3, but shows the interaction of the automated publication specification template distribution and retrieval system with the ad agency's activities. Again, as shown in FIG. 16, the previous manual methodology of FIG. 3 has been replaced by the automated retrieval and integration of the publication template. Thus, at step 1687, the most up-to-date and accurate template is available to the advertiser from the start of the advertiser's activities and also when the media plan is being developed at step 1689. Additionally, the most up-to-date information may be automatically imported into software applications at the ad agency at any point such as step 1691, 1693, 1695, 1677, 1679, 1681, 1683, and 1685, but especially during key process-limiting steps such as determining copy concepts at steps 1693, determining mechanical specifications at step 1695, layout by the desktop artist at step 1679 and production reviews 1681, 1685.

Additionally, FIG. 16 shows how the advertising agency eliminates repeated manual data entry through the use of an embodiment of the present invention. Automatic specification distribution eliminates further manual data when the advertising agency needs to access the publication information. When the advertising agency retrieves publication information the data is up-to-date because it is automatically updated in near-real-time. When the advertiser wants to plan an advertising campaign it can access publication information from the invention as shown in FIG. 6 and stream the data into its business systems, thus eliminating manual data entry. When using the prior art method, publication information is only display rather than integrated into a business system at the advertising agency.

When the advertising agency wants to plan media 1605, the ad agency accesses the publication information as shown in FIG. 6 and streams the data into its business systems, again eliminating manual data entry. Similarly, when the advertising agency wants to initiate a job order/request, the ad agency may access publication information and stream the data into its business systems, again eliminating manual data entry. When the advertising agency begins to open page layout documents for concepts and copy layout, the agency may access publication information as shown in FIG. 6 and stream the data into its business systems, again eliminating manual data entry. When the advertising agency needs to determine mechanical specifications and schedule to meet closing dates, the agency may access publication information as shown in FIG. 6 and stream the data into its business systems, again eliminating manual data entry. When the advertising agency assigns production files to layout by desktop artists, the agency may access publication information as shown in FIG. 6 and stream the data into its business systems, again eliminating manual data entry. When the advertising agency production reviews production materials to insure that advertisements are in compliance with publication information, the agency may access publication information as shown in FIG. 6 and stream the data into its business systems, again eliminating manual data entry. When the advertising agency needs to set-up advertising materials for shipping, the agency may access publication information as shown in FIG. 6 and stream the data into its business systems, again eliminating manual data entry. When the advertising agency needs to send insertion order information to the publisher, the agency may access publication information as shown in FIG. 6 and stream the data into its business systems, again eliminating manual data entry.

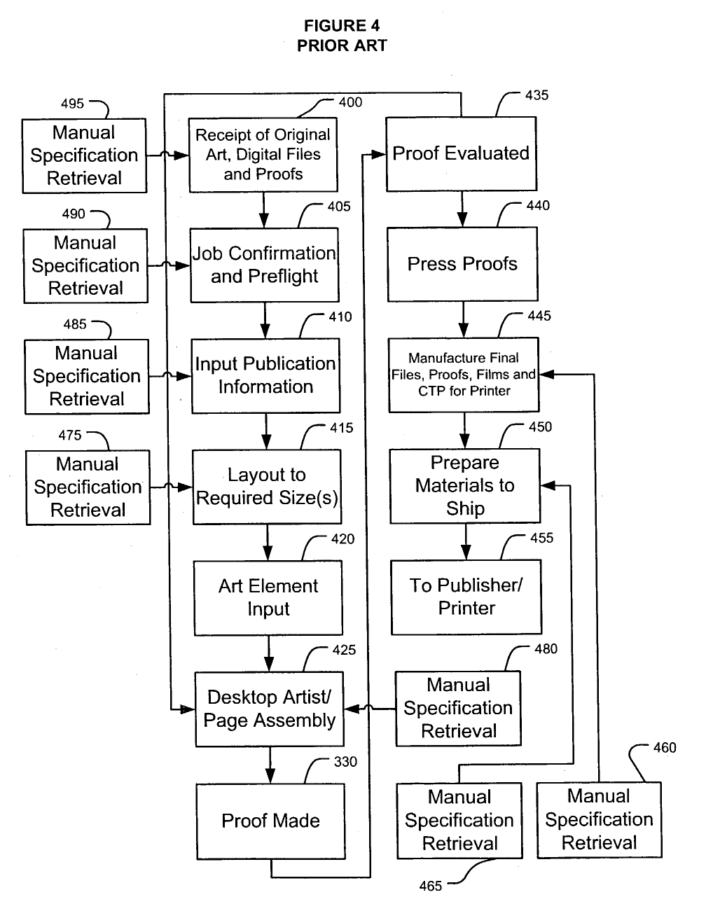

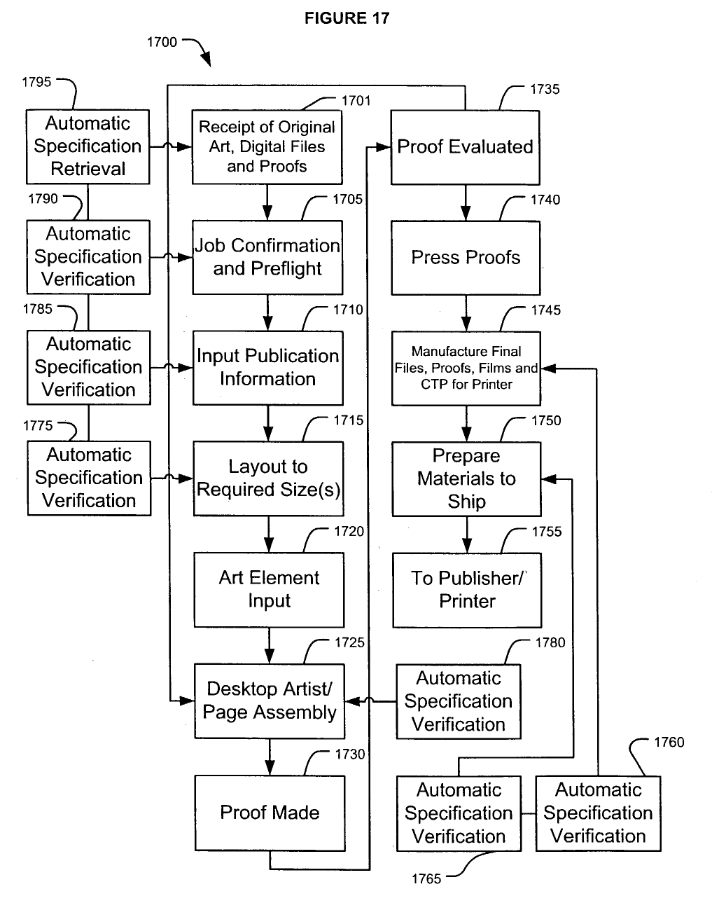

FIG. 17 is similar to FIG. 4, but shows the interaction of the automated publication specification template distribution and retrieval system with the prepress service provider's activities. As shown in FIG. 17, the previous manual methodology of FIG. 4 has been replaced by the automated retrieval and integration of the publication template at steps 1795, 1790, 1785, 1780, 1775, 1760, and 1765. Thus, using the automated template retrieval and integration, the first few steps 1701-1720 of receiving art and digital files, job confirmation, inputting publication information and performing a layout may be collapsed and automated by the integration of the specification template. Additionally, desktop assembly manufacture of final proofs and shipment preparation may also be automatically performed based on the imported template.

Additionally, FIG. 17 shows how the prepress service provider eliminates manual data entry through the use of an embodiment of the present invention. That is, the automatic specification template distribution eliminates further manual data entry when the prepress service provider needs to access the publication information. For example, when the prepress service provider retrieves publication information the data is up-to-date because it is automatically updated in near-real-time. When the prepress service provider receives files from the advertising agency, the prepress service provider may access publication information as shown in FIG. 6 and stream the data into its business systems, again eliminating manual data entry. When the prepress service provider needs to perform preflight analysis to the digital files received from the advertising agency, the prepress service provider may access publication information as shown in FIG. 6 and stream the data into its business systems, especially into its preflight software, again eliminating manual data entry. When the prepress service provider needs to input publication information into the projects job, the prepress service provider may can access publication information as shown in FIG. 6 and stream the data into its business systems, again eliminating manual data entry. When the prepress service provider needs to confirm sizes within the layout, the prepress service provider may access publication information as shown in FIG. 6 and stream the data into its business systems, again eliminating manual data entry. When the prepress service provider assigns the job to the desktop artist/page assembly and information is needed about publication information, the prepress service provider may access publication information as shown in FIG. 6 and stream the data into its business systems, again eliminating manual data entry. When the prepress service provider needs to prepare final materials to deliver to the publisher and the publication printer and needs final materials and file format information from the publication, the prepress service provider may access publication information as shown in FIG. 6 and stream the data into its business systems, again eliminating manual data entry. When the prepress service provider needs to prepare final materials to deliver to the publisher and the publication printer and needs shipping contact and file format information from the publication, the prepress service provider may access publication information as shown in FIG. 6 and stream the data into its business systems, again eliminating manual data entry.

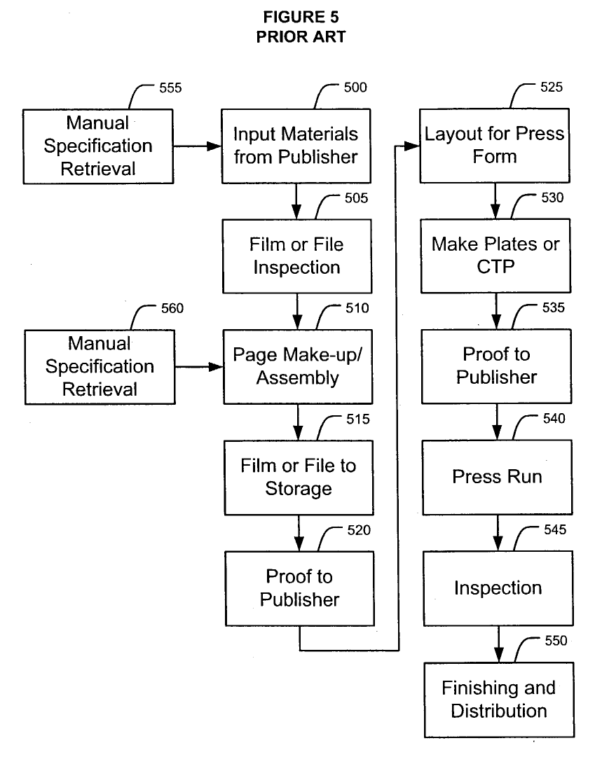

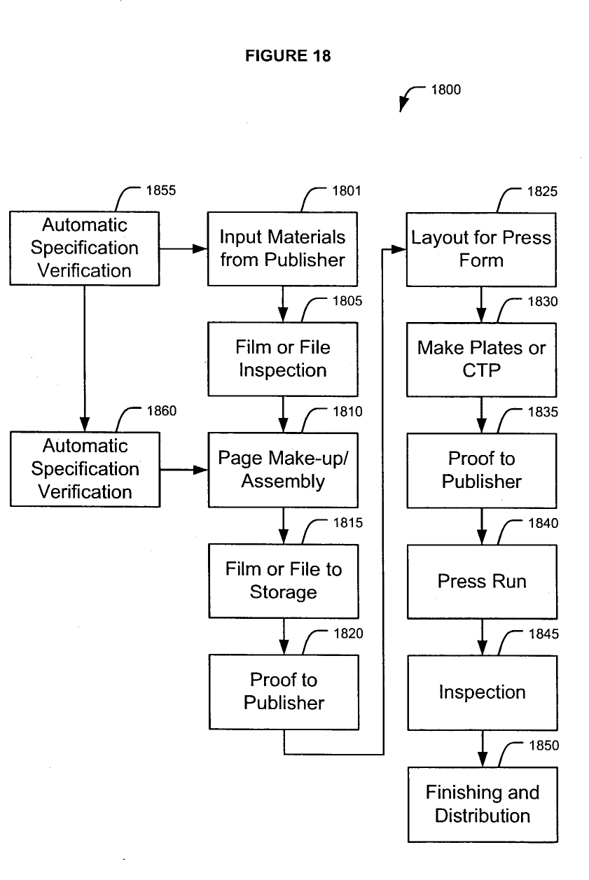

FIG. 18 is similar to FIG. 5, but shows the interaction of the automated publication specification template distribution and retrieval system with the publication printer's activities. As shown in FIG. 18, the previous manual methodology of FIG. 5 has been replaced by the automated retrieval and integration of the publication template at steps 1855 and 1860. Consequently, the printer may be assured that the template data that is being employed in the printing is the most up-to-date and accurate information and that the template data has been employed throughout the ad design process.

Additionally, FIG. 18 shows how the publication printer eliminates manual data entry when it uses the invention. The automatic specification distribution eliminates further manual data entry when the prepress service provider needs to access the publication information. Thus, when input materials are received from the publisher, the data related to each advertisement is embedded within the page layout document.

As illustrated with reference to the above description and drawings, the preferred embodiments of the present invention provide a process for preparing, publishing, exchanging, and analyzing publication information to make it more accessible, timelier, more consistent and ultimately more efficient for use by all the business partners within the enterprise of advertising and magazine publication production. Conversely, the prior art is a manual process that requires telephone calls, facsimile transmissions, and manual visits to web sites to gather and distribute publication information. This invention automates the distribution and retrieval of publication information.

Also, as mentioned above, the use of the prior art manual publication information form suffers from several drawbacks. First, a publication's advertising information is constantly changing. The advertiser must receive accurate and up-to-date information from the publisher. This information is needed to make decisions about purchasing advertising space. Publication information is also needed to guide the preparation and distribution of advertising for magazines. Another recent problem is that publishers may update publication information at different times at different outlets. For example, revised publication specification may be immediately posted on a web site, but the revised specifications may not be sent to advertising agencies for days.

Conversely, the present system automatically updates publication specification information throughout the process at the time when the new publication specifications are first made available by the publisher. All elements of the advertisement production enterprise are provided with convenient, rapid, and accurate access to the most up-to-date publication specifications. Additionally, all release of publication information by a publisher is consolidated into a single template which may be ordered by date of release. Consequently, no discrepancy in publication information is possible.

That is, another problem with the prior art is that the Publisher typically reports its publication information to several data locations: (a) displays specifications on its website, (b) sends written publication information reports including rate data to SRDS, and to Digital Ad Lab SPECbook. The present system eliminates the problem and inefficiency of maintaining data in several locations by employing a process where the publisher has the option to display (post) publication information on its data server, using the template supplied by the invention. The publisher gains improved control of the information because it maintains its publication information and may enter and edit publication information as needed. One advantage of the present system is that changes posted by the publisher are communicated to the marketplace in near real time. This is a result of the process employed by the present system that allows advertisers and their manufacturing partners to get the publication information from a central data server. The present system preferably employs a process that consolidates the information from many publisher sites and automatically updates the central server with changes that have been made to any of the individual Publisher sites.

Additionally, the prior art suffers the drawback of being a manual process that requires telephone calls, facsimile transmissions, and manual visits to web sites to gather and distribute publication information. As may be seen, this is typically quite time intensive. Additionally, the prior art method of data collection (of publication information) requires manual reading and translation and manual data entry. Thus allowing for user error to occur. Another drawback to the prior art is the variety of reporting styles that are typically manufacturing process at the printer. The present system eliminates this non-streaming problem, for example, by creating and implementing a dynamic data stream using eXtensible Markup Language (XML).

Thus, the present system provides a publication advertisement information management system for preparing, publishing, exchanging, and analyzing publication specifications to make them more accessible, timelier, more consistent and ultimately more efficient for advertising page production. Additionally, this invention enables publications and their advertisers to connect and communicate dynamically; it eliminates manual data collection, minimizes manual data entry, shortens information update times to near-real-time, and allows data to stream directly into the users' business systems.

Additionally, the present system allows the user of publication information to be in control of the publication information because the user may integrate the data into its production documents (page layout applications) and business systems. Data integration features of the present system create additional opportunities for management and manufacturing efficiencies. One of these is in the area of file preflighting. Companies such as Markzware, Enfocus, Extensis and Apago offer software products to analyze advertising files prior to deployment into production. These companies, and others, have software programs that are employed in advertising production enterprise. These software programs are made more efficient when they employ the present system to stream publication information into their preflight software programs because the software programs are instantly provided with the most up-to-date specification and may verify the specifications with the central repository as needed. That is, the present system may create a dynamic link between publication information and the preflight applications. The prior art requires that the employed. For example, measuring conventions may be in inches or centimeters or may be in decimals or fractions. Additionally, file formats may be described in a wide variety of ways.

Conversely, in the present system, the process of specification distribution, retrieval, and integration into production software is automatic and does not require manual intervention. Thus, a substantial accuracy improvement is achieved as well as a substantial minimization of work hours wasted retrieving manual specification information. Additionally, the template provides a great deal of flexibility in that the template may support many different industry standards. At the same time, the template standardizes measuring conventions because the actual measuring conventions developed by the publisher may be directly imported into the ad agency's production software by the template.

Another problem with the prior art is that it does not allow publication information data to stream into the users' business systems. Instead the publication information form merely displays data and is not usable by automated systems. Consequently, upgrades to process systems, such as is required for ISO 9002 Registration, is not possible. Additionally, integrating the publication data directly into the page layout application files that are employed by the advertising agency is also not possible. Additionally, publication information data is not able to be integrated into an automated manufacturing process in the prior art.

Conversely, in the present system, publication information may be directly streamed into the user's business systems or other software applications. Consequently, the user or ad agency may implement upgrades such as ISO 9002, while simultaneously integrating publication data directly into the page layout application files and the automated preflight programs gain access to publication information by using inefficient manual data entry methods.

TABLE 1
Table 1 illustrates a comparison of the prior art and the present system:

| Production Step | Invention | Prior Art |
|---|---|---|
| Data Retrieval | Automatic | Manual (phone, fax, |
| | | mail) |
| Data Distribution | XML, HTML | HTML, and printed |
| | | directory |
| Data change-to-update | Near real time | Variable |
| time | | |
| Develop and maintain | Minimal | Extensive, labor |
| data | | intensive |
| Enhancements/ | Easily | Fixed legacy |
| Upgrades | upgradeable | system |
| Data Integration | Yes | No |
| Data integration | Yes | No |
| into user files | | |

The stream of publication specifications is automated by the present system, thus eliminating manual data entry, and allowing the free-flow of publication information. Synergy within the advertising production enterprise (publication data and users of the data) is realized by near-real-time sharing of data. The present system employs information technology (business design for sharing data) to make accurate and swift data sharing an operational fact.

While particular elements, embodiments and applications of the present invention have been shown and described, it will be understood that the invention is not limited thereto since modifications may be made by those skilled in the art, particularly in light of the foregoing teachings. It is therefore contemplated by the appended claims to cover such modifications as incorporate those features which come within the spirit and scope of the invention.

What is claimed is:

1. A system for managing publication advertising specifications including:
a publisher, wherein said publisher develops at least one advertising specification template for at least one publication;
a central repository, wherein an electronic copy of said at least one advertising specification template is stored; and
a user accessing said central repository to receive at least one advertising specification template for at least one publication.
